(19) United States
(12) Patent Application Publication
(10) Pub. No.: US 2017/0036327 A1
(43) Pub. Date: Feb. 9, 2017

(54) ELECTRIC TOOL

(71) Applicant: Hitachi Koki Co., Ltd., Tokyo (JP)

(72) Inventors: Takuhiro Murakami, IBARAKI (JP); Junichi Tokairin, IBARAKI (JP); Shota Takeuchi, IBARAKI (JP); Hironori Mashiko, IBARAKI (JP); Yuta Noguchi, IBARAKI (JP); Akira Matsushita, IBARAKI (JP)

(73) Assignee: Hitachi Koki Co., Ltd., Tokyo (JP)

(21) Appl. No.: 15/224,677

(22) Filed: Aug. 1, 2016

(30) Foreign Application Priority Data
Aug. 7, 2015 (JP) 2015-157817
Mar. 31, 2016 (JP) 2016-070906

(51) Int. Cl. B25B 21/02

(52) U.S. Cl. CPC B25B 21/026

(57) ABSTRACT

Provided is an impact type electric tool. A striking mechanism is used, which uses a hammer having striking claws that are equally arranged in the rotational direction and an anvil having struck claws. A relationship between a striking energy E, which the hammer has right before striking the anvil, and a disengaging torque T_{B}, which is applied between the hammer and the anvil right before the hammer is disengaged from the anvil, is set as 5.3×T_{B}<E<9.3×T_{B} in the case of three claws and set as 9.3×T_{B}<E<15.0×T_{B} in the case of two claws, so as to perform striking by skipping one of the claws of the hammer and the anvil when a high torque is required. Accordingly, the electric tool achieves output of a high torque while maintaining a favorable operational feeling during striking.

### CROSS-REFERENCE TO RELATED APPLICATION

This application claims the priority benefits of Japan application serial no. 2015-157817, filed on Aug. 7, 2015, and Japan application serial no. 2016-070906, filed on Mar. 31, 2016. The entirety of each of the above-mentioned patent applications is hereby incorporated by reference herein and made a part of this specification.

### BACKGROUND OF THE INVENTION

### Field of the Invention

The invention relates to an impact type electric tool, in which a hammer is capable of applying a striking force to an anvil in a rotational direction.

### Description of Related Art

Conventionally, an electric tool is known as a device for transmitting a rotational force of a motor to a hammer so as to apply a striking force in the rotational direction to an anvil through the hammer. The impact tool disclosed in Japanese Patent Publication No. S59-88264 is one example. The impact tool is widely used for works such as fastening screw members into lumber or fixing bolts into concrete, loosening screw members or bolts, and so on. When a trigger of a trigger switch is pulled, a motor in the impact tool is driven to rotate a spindle via a speed reduction mechanism. As the spindle is rotated, the hammer connected to the spindle by a hammer spring and cam balls rotates. When the hammer rotates, a rotational force is transmitted through striking claws of the hammer and blade parts of the anvil to rotate the anvil. An end of the anvil in the axial direction is formed with a mounting hole for mounting a tip tool. A screw or bolt can be fastened by using the tip tool, e.g. a hexagonal bit, mounted in the mounting hole.

In the case of performing the fastening process on lumber, drywall screw is used, for example. When the impact tool is used to fasten the drywall screw, the hammer and the anvil rotate synchronously (continuous rotation) for a little while after the fastening begins. Then, a counter torque generated by the drywall screw increases gradually as the fastening proceeds, and when the counter torque exceeds the spring pressure of the hammer spring, the hammer gradually compresses the hammer spring and gradually retreats to the motor side along the shapes of spindle cam grooves and hammer cam grooves. Because of the retreat of the hammer, a contact length of the striking claws of the hammer and the struck claws of the anvil in the front-rear direction is decreasing. When the contact length of the striking claws of the hammer and the struck claws of the anvil in the front-rear direction becomes 0 mm, the hammer engaged with the anvil with respect to the rotational direction is disengaged therefrom. The value of the torque applied between the hammer and the anvil right before the disengagement is a “disengaging torque” at the time the hammer and the anvil disengage from each other.

When the counter force from the drywall screw exceeds the disengaging torque, the striking claws of the hammer move over the struck claws of the anvil and then the hammer becomes engaged (or collides) with the next struck claw of the anvil as being pushed out to the side of the hexagonal bit by the compression force of the hammer spring. The striking claws on the hammer and the blade parts on the anvil repeat the operation of disengagement and engagement (striking operation) till the fastening of the drywall screw is completed. As the drywall screw is fastened into the lumber, the counter torque from the drywall screw increases gradually, which also raises the hammer back amount. The reason is that the rate of repulsion that occurs between the hammer and the anvil increases with the counter torque generated by the drywall screw.

### PRIOR ART LITERATURE

### Patent Literature

Patent Literature 1: Japanese Patent Publication No. S59-88264

### SUMMARY OF THE INVENTION

### Problem to be Solved

In recent years, high-torque impact tools have been realized and products that output a fastening torque of 150N·m or more are also available in the market. In order to increase the fastening torque of impact tools, a spring constant of the spring for pushing the hammer toward the anvil side is set high. However, the inventors found that, if the spring constant of the spring is increased to achieve high output power, the disengaging torque also increases and the following problems occur.

The timing of transition from continuous rotation to the striking operation is delayed when the disengaging torque increases. Thus, the counter torque applied on the impact tool increases and makes it difficult for the operator to hold the impact tool in one hand to fasten screws. Moreover, in the case of fastening screws into soft wood or the like that does not require a high fastening torque, the impact tool with the increased spring constant may not reach the disengaging torque in the screw fastening operation, which results in the problem that the striking operation is hard to carry out. If the striking operation could not be performed, the screw threads of the tip tool may easily float from the cross groove of the drywall screw and the hexagonal bit may come off and be repelled. In that case, the tip tool rotates idly and damages the screw head of the drywall screw. In this way, the impact tool does not perform its characteristics when the disengaging torque is too high and particularly the effect of preventing cam-out is not achieved.

In view of the above background, the invention provides an impact type electric tool that suppresses increase of the disengaging torque of the hammer and the anvil and enhances the striking force in the rotational direction to achieve high output power as well as allows the operator to carry out the screw fastening operation by holding the electric tool in one hand.

The invention also provides an electric tool that achieves high output power as well as improves the operation feeling during transition from continuous rotation to striking. The invention further provides an electric tool, in which the hammer striking claw strikes the struck claw following the next struck claw of the anvil to ensure a sufficient fastening torque without increasing the spring constant of the hammer spring.

### Solution to the Problem

The invention is described as follows. According to a feature of the invention, an electric tool includes a motor, a spindle that is driven in a rotational direction by the motor, a hammer that is relatively movable in an axial direction and the rotational direction in a predetermined range with respect to the spindle and urged forward by a cam mechanism and a spring, and an anvil that is disposed rotatably in front of the hammer to be struck by the hammer when the hammer rotates while moving forward. The hammer has three striking claws that are arranged equally in the rotational direction and the anvil has three struck claws that are arranged equally in the rotational direction. A striking operation is performed in a range that a relationship between a striking energy E, which the hammer has right before the hammer strikes the anvil, and a disengaging torque T_{B}, which is applied between the hammer and the anvil right before the hammer is disengaged from the anvil, is set as E>5.3×T_{B}. Moreover, when striking is performed in the range of the disengaging torque T_{B}, a range of a relative rotation angle of the hammer with respect to the anvil from when the hammer strikes the anvil till the hammer strikes the anvil again after the hammer stroke the anvil and moved rearward is set to substantially 240 degrees, and a revolution speed of the motor is controlled to carry out “one-skip striking” that the striking claw moves over the next struck claw to strike the struck claw following the next struck claw. The revolution speed is a revolution speed when a trigger is pulled to the maximum or to a state close to the maximum. In this configuration, a striking timing is improved even if the practical revolution speed of the spindle is set to 2,300 rpm or more, and a fastening torque is sufficiently enhanced while a ratio of the disengaging torque to the striking energy is small. Additionally, in contrast to the increasing fastening torque, the disengaging torque remains equal to the conventional torque. Therefore, like the conventional product, a high-output screw fastening process can be performed with one hand.

According to another feature of the invention, an upper limit of the striking energy E is set as 9.3×T_{B}>E. By restricting the disengaging torque T_{B} in this way, the so-called “one-skip striking” is carried out at a favorable timing. Here, preferably a diameter of the hammer is 35 mm-44 mm, an inertia of the hammer is 0.39 kg·cm²[0.00038N·m²] or less, a diameter of the spindle is 10 mm-15 mm, and a spring constant of the spring is 37 kgf/cm or less. In addition, when a maximum engagement amount, which is an engagement length of the anvil and the hammer in the axial direction when the anvil is at a foremost position, is set to A [mm] and a cam lead angle, which is a lead angle between cams disposed on the hammer and the spindle such that the hammer retreats when the hammer rotates relatively with respect to the spindle, is set to θ [deg], a relationship between A and θ is set as (−0.125×θ+7.5)−0.7<A<(−0.125×θ+7.5)+0.7. When the relational equation is satisfied, the timing from continuous rotation of the hammer to the start of the striking operation is improved.

According to another feature of the invention, an overlapping length of the striking claws and the struck claws in the axial direction when a counter torque received from a tip tool mounted on the anvil is small is 2.3 mm-5.0 mm, and the lead angles θ of a cam groove of the hammer and a cam groove of the spindle are made equal and set as θ=26-36 degrees. In this configuration, a rotation speed of the spindle is adjusted such that the striking claw strikes the next struck claw, or to perform the one-skip striking that the striking claw moves over the next struck claw to strike the struck claw following the next struck claw when the hammer retreats to disengage the striking claw from the struck claw and rotates.

According to yet another feature of the invention, in an impact type electric tool, a hammer has two striking claws while an anvil has two struck claws. A striking operation is performed in a range that a relationship between a striking energy E, which the hammer has right before the hammer strikes the anvil, and a disengaging torque T_{B}, which is applied between the hammer and the anvil right before the hammer is disengaged from the anvil, is set as 9.3×T_{B}<E<15.0×T_{B}. Moreover, when striking is performed in the range of the disengaging torque T_{B}, a range of a relative rotation angle of the hammer with respect to the anvil from when the hammer strikes the anvil till the hammer strikes the anvil again after the hammer stroke the anvil and moved rearward is set to substantially 360 degrees, and a revolution speed of the motor is controlled to carry out “one-skip striking” that the striking claw moves over the next struck claw to strike the struck claw following the next struck claw. The revolution speed is a revolution speed when the trigger is pulled to the maximum or in a state close to the maximum. In this configuration, a striking timing is improved even if the practical revolution speed of the spindle is set to 2,100 rpm or more, and a fastening torque is sufficiently enhanced while a ratio of the disengaging torque to the striking energy is small.

The aforementioned and other features of the invention can be understood through the description of the specification and the figures below.

### BRIEF DESCRIPTION OF THE DRAWINGS

FIG. 1 is a longitudinal cross-sectional view showing the internal structure of the impact tool 1 according to an embodiment of the invention.

FIG. 2 is a partially enlarged view of the striking mechanism part of FIG. 1.

FIG. 3(1) and FIG. 3(2) are front view and longitudinal cross-sectional view of the anvil 60 of FIG. 1.

FIG. 4(1) and FIG. 4(2) are front view and longitudinal cross-sectional view of the hammer 40 of FIG. 1.

FIG. 5(1) and FIG. 5(2) are front view and side view of the spindle 30 of FIG. 1.

FIG. 6(1) and FIG. 6(2) are views for illustrating the striking angle during one-skip striking of the hammer 40 and the anvil 60 of FIG. 1.

FIG. 7 is a diagram showing the striking condition based on the striking angle of FIG. 6(1) and FIG. 6(2).

FIG. 8(1) and FIG. 8(2) are views for illustrating the striking angle during continuous striking of the hammer 40 and the anvil 60 of FIG. 1.

FIG. 9 is a diagram showing the striking condition based on the striking angle of FIG. 8(1) and FIG. 8(2).

FIG. 10 is a diagram showing the relationship between the striking energy and the disengaging torque of the impact tool 1 according to an embodiment of the invention.

FIG. 11 is a diagram showing the relationship between the maximum engagement amount A and the cam lead angle θ of the impact tool 1 according to an embodiment of the invention.

FIG. 12 is a longitudinal cross-sectional view showing the internal structure of the impact tool 101 according to the second embodiment of the invention.

FIG. 13(1) and FIG. 13(2) are partially enlarged views of the striking mechanism part of FIG. 12, wherein FIG. 13(1) is a cross-sectional view and FIG. 13(2) is a side view.

FIG. 14(1) and FIG. 14(2) are front view and longitudinal cross-sectional view of the anvil 160 of FIG. 12.

FIG. 15(1) and FIG. 15(2) are front view and longitudinal cross-sectional view of the hammer 140 of FIG. 12.

FIG. 16(1), FIG. 16(2), and FIG. 16(3) are front view, side view, and cross-sectional view of the spindle 130 of FIG. 12.

FIG. 17(1) and FIG. 17(2) are views for illustrating the striking angle during one-skip striking of the hammer 140 and the anvil 160 of FIG. 12.

FIG. 18 is a diagram showing the striking condition based on the striking angle of FIG. 17(1) and FIG. 17(2).

FIG. 19(1) and FIG. 19(2) are views for illustrating the striking angle during continuous striking of the hammer 140 and the anvil 160 of FIG. 12.

FIG. 20 is a diagram showing the striking condition based on the striking angle of FIG. 19(1) and FIG. 19(2).

FIG. 21 is a diagram showing the relationship between the striking energy and the disengaging torque of the impact tool 101 according to the second embodiment.

FIG. 22 is a diagram showing the relationship between the maximum engagement amount F and the cam lead angle θ₁ of the impact tool 101 according to the second embodiment.

### DESCRIPTION OF THE EMBODIMENTS

### Embodiment 1

Hereinafter, embodiments of the invention are described with reference to the figures. In the following description, the vertical direction and the front-rear direction refer to the directions shown in the figures. This embodiment illustrates an impact tool as an embodiment of the electric tool.

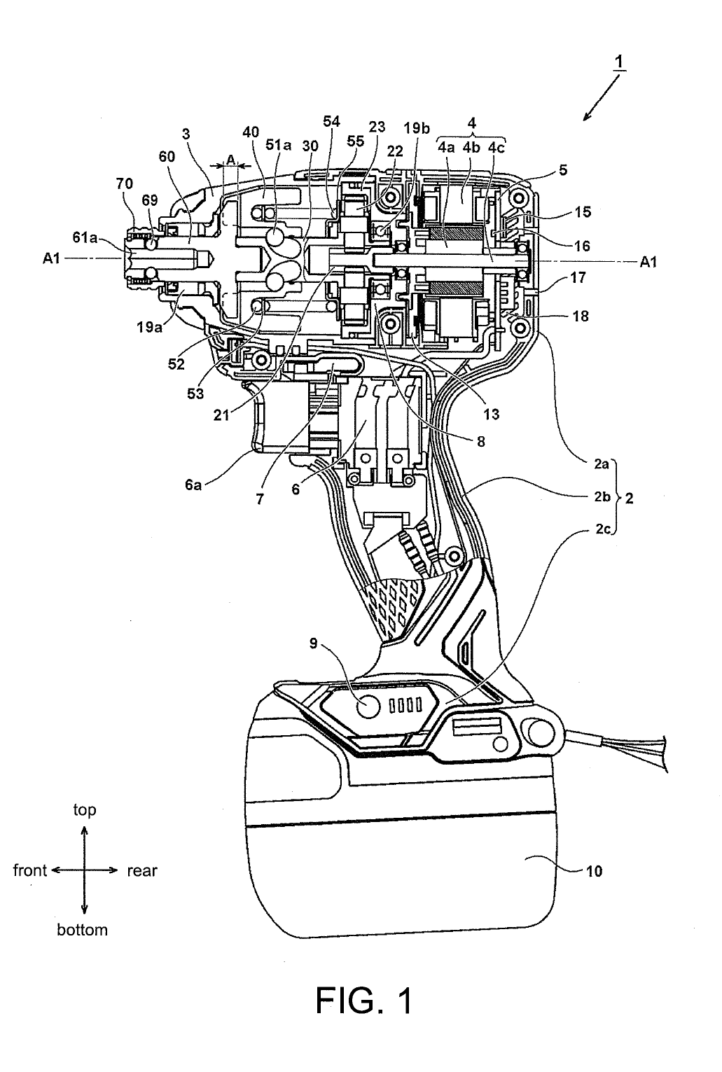

FIG. 1 is a longitudinal cross-sectional view showing the internal structure of an impact tool 1 according to an embodiment of the invention. A housing of the impact tool 1 includes a body housing 2 and a hammer case 3 disposed therein. The impact tool 1 uses a rechargeable battery 10 as a power source and a motor 4 as a driving source to drive a rotational striking mechanism. A rotational force and a striking force from the striking mechanism are applied to an anvil 60 that serves as an output shaft, and the rotational striking force is continuously or intermittently transmitted to a tip tool (not shown), such as a driver bit, held in a mounting hole 61a formed on a bit holding part 70, so as to carry out an operation of fastening screws or bolts.

The brushless DC (direct current) type motor 4 is housed in a cylindrical body part 2a of the body housing 2 that has a substantially T shape in a side view. A rotation shaft 4c of the motor 4 is disposed such that an axis A1 thereof extends in a longitudinal direction of the body part 2a. A rotor 4a is for forming a magnetic path that is formed by a permanent magnet and includes a laminated core, e.g., a thin metal plate, and a cylindrical permanent magnet is disposed on the outer peripheral side of the laminated core. A stator core 4b is formed by a laminated core and has a plurality of pole pieces that protrude radially inward, and a coil of predetermined turns is wound on each of the pole pieces. Y connection can be adopted for connecting the coil, for example. On the rear side of the motor 4 in the axial direction and behind the stator core 4b, an inverter circuit board 5 is disposed for driving the motor 4. The inverter circuit board 5 is a substantially annular double-sided substrate, wherein a plurality of switching elements 15, e.g., field effect transistor (FET), are mounted on the rear side of the substrate and a plurality of rotational position detecting elements 16, e.g., Hall IC, are mounted on the front side at predetermined intervals at positions opposite to the permanent magnet of the rotor 4a. A cooling fan 13 is disposed on the rotation shaft 4c on the front side of the motor 4 to rotate in synchronization with the motor 4. External air is sucked through air inlets 17 and 18 on the rear of the body housing 2 by rotation of the cooling fan 13 to cool the motor 4 or the switching elements 15 and then discharged outside through an air outlet (not shown) formed around the cooling fan 13.

A trigger switch 6 is disposed in the upper portion of a handle part 2b that extends integrally and substantially orthogonally from the body part 2a of the body housing 2. A trigger 6a that serves as an operating lever is exposed to the front side of the body housing 2 from the trigger switch 6. In addition, a forward-reverse switching lever 7 for switching the rotational direction of the motor 4 is disposed above the trigger switch 6. An enlarged diameter part 2c is formed in the lower portion of the handle part 2b for attaching the battery 10. The enlarged diameter part 2c is a part formed to expand radially (orthogonal direction) from a longitudinal central axis of the handle part 2b, and the battery 10 is mounted on the lower side of the enlarged diameter part 2c. In the enlarged diameter part 2c, a control circuit board (not shown) is housed which has a function of controlling the speed of the motor 4 according to an operation of pulling the trigger 6a. The control circuit board is disposed to be substantially horizontal. A microcomputer (also referred to as “MCU” hereinafter) is mounted on the control circuit board. In addition, a changeover switch 9 for changing the operation mode is provided on a side surface of the enlarged diameter part 2c. A secondary battery such as nickel hydrogen battery or lithium ion battery is used as the battery 10, and a battery pack that contains a plurality of cells in a battery housing is used.

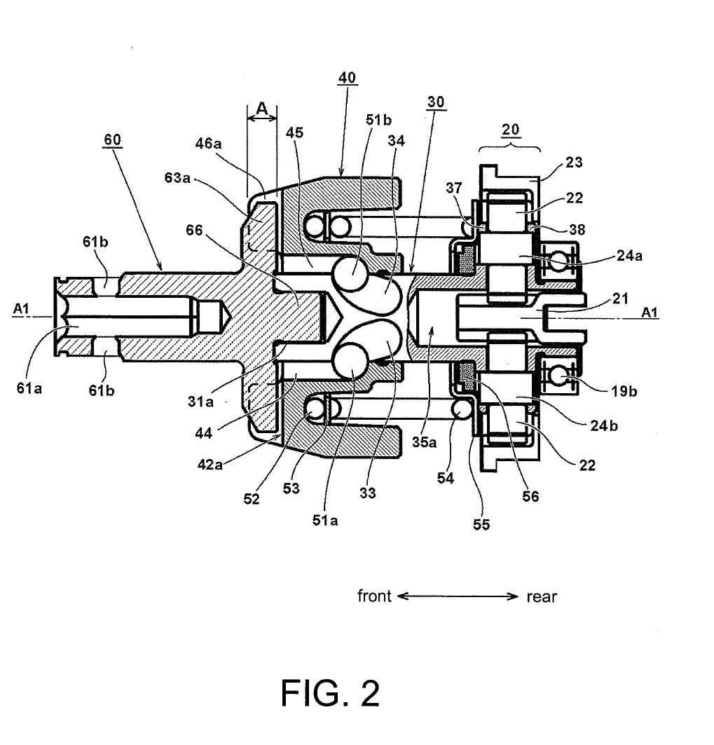

FIG. 2 is a partially enlarged view that illustrates the power transmission mechanism part between the rotation shaft 4c of the motor 4 and the mounting hole 61a of FIG. 1. The rotational driving force of the motor 4 is transmitted from the rotation shaft 4c to the side of the rotational striking mechanism via a speed reduction mechanism 20 that uses planetary gears. The speed reduction mechanism 20 transmits the output of the motor 4 to a spindle 30. Here, the speed reduction mechanism that uses planetary gears is adopted. The speed reduction mechanism 20 includes a sun gear 21 fixed to an end of the rotation shaft 4c of the motor 4, a ring gear 23 disposed to surround the sun gear 21 at a distance on the outer peripheral side, and a plurality of planetary gears 22 (here, the number is three) disposed between and engaged with the sun gear 21 and the ring gear 23. The three planetary gears 22 revolve around the sun gear 21 while rotating around shafts 24a-24c (24c is not shown) respectively. The ring gear 23 is fixed to the side of the body housing 2 and does not rotate. The shafts 24a-24c (as described below with reference to FIG. 2) are fixed to planetary carrier parts (attachment parts 37 and 38) that are formed on a rear end portion of the spindle 30. The revolution motion of the planetary gears 22 is converted into the rotational motion of the planetary carrier parts to rotate the spindle 30.

The spindle 30 is disposed on the front side coaxially with the speed reduction mechanism 20. In this embodiment, on the rear side of a columnar spindle shaft part 31 where spindle cam grooves 33 and 34 are formed, the planetary carrier parts of the speed reduction mechanism 20 are connected and these are manufactured integrally from a piece of metal. On an end of the spindle 30 on the side of the motor 4, a cylindrical hole 35a recessed toward the front side in a direction along the axis A1 is formed to serve as a housing space of the sun gear 21. Further, on an end of the spindle 30 on the side of the anvil 60, a cylindrical fitting hole 31a is formed to be recessed rearward along the axis A1.

The hammer 40 is mounted from the front side (left side of the figure) of the spindle 30 and is disposed such that the outer peripheral surface of the shaft part of the spindle 30 and a portion of the inner peripheral surface of the hammer 40 on the rear side are in contact with each other. On the outer peripheral surface of the cylindrical portion of the spindle 30, the spindle cam grooves 33 and 34 are formed, which are recessed portions having a substantially V shape in the side view of the spindle 30. Hammer cam grooves 44 and 45 are formed on the inner peripheral surface of the hammer 40 opposite to the spindle cam grooves 33 and 34. The spindle 30 and the hammer 40 are combined in a way that a predetermined space is formed by the spindle cam grooves 33 and 34 and the hammer cam grooves 44 and 45. Metallic cam balls 51a and 51b are disposed in the space, so as to form a cam mechanism. The cam mechanism allows the hammer 40 to rotate substantially in linkage with the spindle 30. The cam balls 51a and 51b move in the space, by which the relative positions of the hammer 40 and the spindle 30 in the rotational direction change slightly. The hammer 40 is slightly movable with respect to the spindle 30 in the axial direction and is movable to a large extent toward the rear side. Moreover, because the hammer 40 is constantly urged toward the front side with respect to the spindle 30 by the spring 54, rearward movement of the hammer 40 will compress the spring 54.

When the spindle 30 is stationary, due to the balance relationship between the engagement positions of the cam balls 51a and 51b, the spindle cam grooves 33 and 34, and the hammer cam grooves 44 and 45 and the urging force with respect to the spring 54, a front surface 42a of the hammer 40 and the rear end surface of the claw part of the anvil 60 are at positions spaced by a slight gap in the axial direction. Meanwhile, the blade part 63a of the anvil 60 and the striking claw 46a of the hammer 40 are in a positional relationship that they overlap each other in the direction of the axis A1, and a length of the engagement in the axial direction is an engagement amount A. Here, the engagement amount A is an axial length of a contact area of the striking claws 46a-46c of the hammer 40 and the blade parts 63a-63c of the anvil 60 when viewed in the direction of the axis A1, and as shown in FIG. 2, the engagement amount A has a maximum value when they are stationary or at the initial positions before striking. The engagement amount A changes according to the rearward movement of the hammer 40, and when the counter torque transmitted to the hammer 40 increases due to the force that the anvil 60 receives from the tip tool side, the positions of the cam balls 51a and 51b move and cause the relative positional relationship between the hammer 40 and the anvil 60 to change.

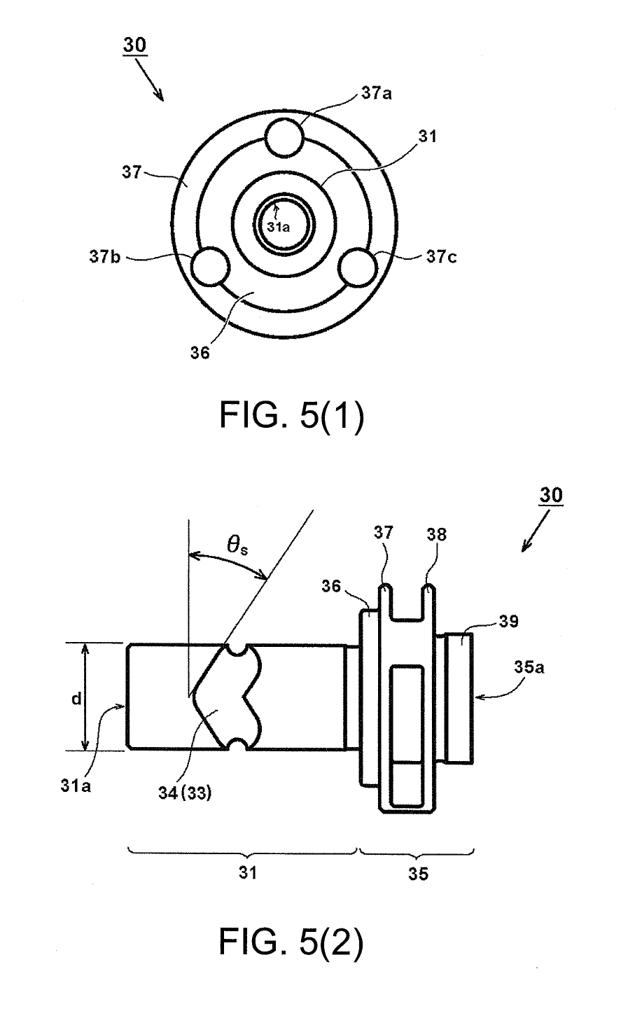

The spring 54 is a compression spring. On the front side of the spring 54, a plurality of steel balls 52 are disposed in a state of being pressed by a washer 53, and the rear side of the spring 54 is fixed on a stepped part 36 (refer to FIG. 5(2)) of the spindle 30 by a stepped washer 55. On the inner peripheral side of the washer 55, an annular damper 56 is disposed, which is formed for the spindle 30 to pass through in the center. The damper 56 is composed of an elastic material such as rubber and prevents direct collision with the speed reduction mechanism 20 when the hammer 40 retreats to the maximum extent and thereby alleviates the impact when the cam balls 51a and 51b collide with the ends of the spindle cam grooves 33 and 34 and the ends of the hammer cam grooves 44 and 45.

The striking mechanism and the speed reduction mechanism including and composed of the spindle 30, the hammer 40, and the anvil 60 are disposed in a way that the rotation centers of the spindle 30, the hammer 40, and the anvil 60 line up along the axis A1, and are housed inside the tapered metallic hammer case 3 and fixed to the front side of the body housing 2. The assembly shown in FIG. 2 is pivotally supported in the hammer case 3 by a metal 19a at the front side and pivotally supported in the body housing 2 via a bearing 19b and a bearing holder 8 (refer to FIG. 1) at the rear side.

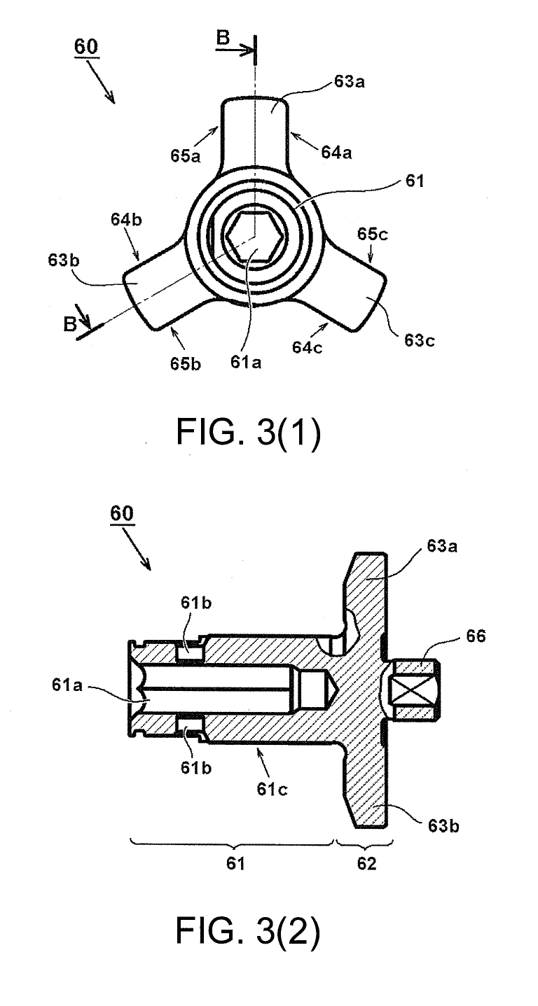

Next, a shape of the anvil 60 is described with reference to FIG. 3(1) and FIG. 3(2). FIG. 3(1) is a front view of the anvil 60 and FIG. 3(2) is a cross-sectional view along the section B-B. Here, please note that, to facilitate understanding of the invention, FIG. 3(2) is a cross-sectional view along the section B-B of FIG. 3(1). Moreover, only the anvil 60 and the struck claws, the striking claw portion of the hammer 40, and the planetary gears 22 of the speed reduction mechanism in the cross-sectional views of FIG. 1 and FIG. 2 are shown in the cross-sectional view along the section B-B. The impact tool 1 needs to be designed such that the striking claws of the hammer 40 do not pre hit or over shoot the blade parts of the anvil 60 when the engaging parts (the striking claws and the struck claws) provided on the hammer 40 and the anvil 60 are repeatedly disengaged from and engaged with one another. The reason is that if pre hit or over shoot occurs, the impact tool 1 may vibrate greatly and cause the performance to drop significantly. In order to prevent the aforementioned problem, generally the number of the hammer claws and the number of the blade parts of the anvil in the conventional impact tool 1 are both two. If the number of the striking claws is three or more, the rotation angle will be 180 degrees or less. Consequently, pre hit is likely to occur. On the other hand, if the number of the striking claws is one, the rotation angle will be 360 degrees and over shoot may occur easily, and a hammer back amount also needs to be increased. The foregoing is an obstacle to achieving a compact product. According to this embodiment, the number of the striking claws of the hammer 40 and the number of the blade parts of the anvil 60 are both set to three and the spindle 30 is controlled in a predetermined speed range, so as to achieve smooth transition from continuous rotation to striking as well as realize a high-torque impact tool.

The anvil 60 is manufactured integrally from a piece of metal, wherein a struck part 62 with three blade parts 63a-63c is formed at the rear of a cylindrical output shaft part 61 of the anvil 60. The mounting hole 61a having a hexagonal cross-sectional shape is formed into an inner portion of the output shaft part 61 from a front end part for mounting the tip tool. Two through holes 61b are formed to penetrate the output shaft part 61 in the radial direction in the middle of the portion where the mounting hole 61a is formed in the front-rear direction, and metal balls 69 (refer to FIG. 1) are disposed therein to serve as components of the bit holding part 70. The outer peripheral surface between the through holes 61b and the struck part 62 (the portion indicated by the arrow 61c) is formed into a columnar shape when viewed in the axial direction. The metal 19a (refer to FIG. 1) is disposed on the outer peripheral side of this region to pivotally support the anvil 60 in the hammer case 3 in a rotatable manner (refer to FIG. 1). The three blade parts 63a-63c of the struck part 62 are struck claws that are arranged at equal intervals of 120 degrees when viewed in the rotational direction and extend outward in the radial direction. On side surfaces of the blade parts 63a-63c in the rotational direction, struck surfaces 64a-64c and struck surfaces 65a-65c are formed, wherein the struck surfaces 64a-64c are to be struck by the striking claws of the hammer 40 during rotation in a fastening direction, and the struck surfaces 65a-65c are formed on the opposite sides to be struck during rotation in a loosening direction. A cylindrical shaft part 66 is formed on the rear side of the struck part 62, and the outer peripheral surface of the shaft part 66 is pivotally supported by the fitting hole 31a of the spindle 30 in a slidable manner (refer to FIG. 2).

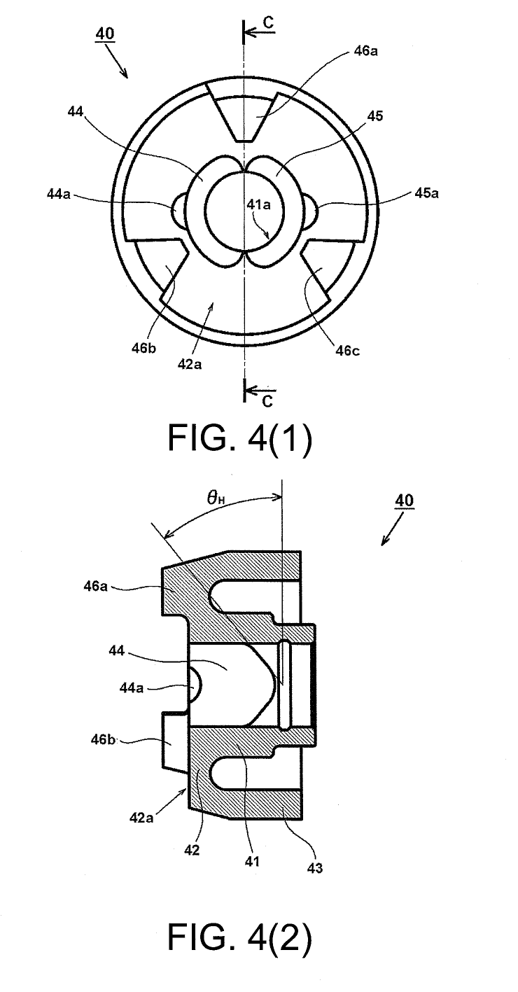

Next, a shape of the hammer 40 is described with reference to FIG. 4(1) and FIG. 4(2). FIG. 4(1) is a front view of the hammer 40 and FIG. 4(2) is a cross-sectional view along the section C-C. As shown in FIG. 4(2), the hammer 40 has a shape that front sides of two cylindrical portions 41 and 43 that have different inner diameters are connected by a connection part 42 in the radial direction. Here, the hammer 40 is made of a metal. The hammer 40 may be configured to have a diameter (outer diameter) of about 35-44 mm and an inertia of 0.39 kg·cm²[0.00038N·m²] or less. The three striking claws 46a-46c that protrude toward the front side (the side of the anvil 60) in the axial direction are formed at three positions on the outer peripheral side of the front surface 42a which is formed by the connection part 42. As shown in FIG. 4(1), the striking claws 46a-46c are equally arranged in a way that the central positions of the striking claws 46a-46c are respectively separated by a rotation angle of 120 degrees when viewed in the rotational direction. Two side surfaces of each of the striking claws 46a-46c in the rotational direction are arranged at predetermined angles in the rotational direction to achieve proper surface contact when colliding with the three blade parts 63a-63c of the anvil 60. The hammer cam grooves 44 and 45 are formed on the inner peripheral side of the cylindrical portion 41 of the hammer and on an inner wall portion of a through hole 41a which faces the outer surface (cylindrical surface) of the spindle 30. The hammer cam grooves 44 and 45 are recesses, which respectively have a substantially trapezoidal contour if the inner peripheral surface of the hammer 40 is unfolded into a plane, and form a space that restricts movement of the cam balls 51a and 51b with the spindle cam grooves 33 and 34. In addition, grooves 44a and 45a for inserting the cam balls 51a and 51b during assembly are formed on a portion of the hammer cam grooves 44 and 45. In this embodiment, a cam lead angle θ_{H} of the hammer 40 is set within a range, e.g., θ_{H}=26-36 degrees, for example, to make the cam lead angle θ_{H} a predetermined value.

Next, a shape of the spindle 30 is described with reference to FIG. 5(1) and FIG. 5(2). FIG. 5(1) is a front view of the spindle 30 and FIG. 5(2) is a side view. The spindle 30 is disposed coaxially with the axis A1 between the anvil 60 and the speed reduction mechanism 20 and a rear end part 39 of the spindle 30 in the longitudinal direction is pivotally supported by the bearing 19b (refer to FIG. 1). The spindle 30 is made of a metal and a diameter d of the shaft part 31 may be about 10-15 mm. The bearing 19b is fixed to the body housing 2 via the bearing holder 8 (refer to FIG. 1). The two spindle cam grooves 33 and 34 are formed on the outer peripheral surface of the spindle 30. Here, the spindle cam groove 33 is separated from the spindle cam groove 34 by an angle of 180 degrees in the rotational direction and therefore cannot be seen in FIG. 5(2), but the spindle cam groove 33 has the same shape as the spindle cam groove 34. The spindle cam grooves 33 and 34 respectively have a substantially V shape in the side view (when viewed in an upper direction orthogonal to the axis A1), and a cam lead angle θ_{S} of each of the spindle cam grooves 33 and 34 is set to a predetermined angle. In this embodiment, the cam lead angle θ_{H} of the hammer 40 and the cam lead angle θ_{S} of the spindle 30 are set to be the same in the range of 26-36 degrees, for example. The disengaging torque and a maximum current during practical use rise as the cam lead angles θ_{H} and θ_{S} increase; on the other hand, the disengaging torque and the maximum current during practical use both drop as the cam lead angles θ_{H} and θ_{S} decrease. Thus, maintaining a balance between the foregoing is important.

A planetary carrier part 35 of the speed reduction mechanism 20 is formed and the attachment parts 37 and 38 are formed on the rear side of the columnar spindle shaft part 31. The attachment part 37 extends to be orthogonal to the axis A1 and is formed with three fitting holes 37a-37c that are arranged at equal intervals in the rotational direction. The attachment part 38 is disposed in parallel to the attachment part 37 on the rear side at a predetermined distance from the attachment part 37. The attachment part 38 is also formed with three fitting holes (not shown) that are arranged at equal intervals in the rotational direction and fix the shafts 24a-24c (also refer to FIG. 2), which pivotally support the planetary gears 22 with the fitting holes 37a-37c of the attachment part 37. The stepped part 36 having an increased thickness in the axial direction is formed on the front side of the attachment part 37.

When the trigger 6a is pulled to activate the motor 4, the motor 4 starts to rotate in the direction set by the forward-reverse switching lever 7 and the rotational force is reduced at a predetermined reduction ratio by the speed reduction mechanism 20 and transmitted to the spindle 30 to drive the spindle 30 to rotate at a predetermined speed. Here, the spindle 30 and the hammer 40 are connected by the cam mechanism, and when the spindle 30 is driven to rotate, the rotation is transmitted to the hammer 40 via the cam mechanism. When the rotation begins and before the hammer 40 reaches ⅓ of the rotation, the striking claws 46a-46c of the hammer 40 abut against the blade parts 63a-63c of the anvil 60 and cause the anvil 60 to rotate. At the moment, when the engagement counter force from the anvil 60 causes relative rotation between the spindle 30 and the hammer 40, the hammer 40 starts to retreat toward the side of the motor 4 while compressing the spring 54 along the spindle cam grooves 33 and 34 of the cam mechanism. Then, when the striking claws 46a-46c of the hammer 40 move over the blade parts 63a-63c of the anvil 60 due to the retreat of the hammer 40 to release the hammer 40 and the anvil 60 from the engagement state, the hammer 40 is rapidly accelerated forward and rotated in the rotational direction by the elastic energy accumulated in the spring 54 and the function of the cam mechanism in addition to the rotational force of the spindle 30.

When the hammer 40 is moved forward by the urging force of the spring 54, the striking claws 46a-46c of the hammer 40 are engaged with the next blade parts 63a-63c of the anvil 60 again during the rotation, so as to perform strong striking and the hammer 40 and the anvil 60 start to rotate together. The striking applies a strong rotational force to the anvil 60. Thus, a rotational striking force is transmitted to a screw through the tip tool (not shown) which is mounted in the mounting hole 61a of the anvil 60. Thereafter, the same operation is repeated to intermittently and repeatedly transmit the rotational striking force from the tip tool to the screw, so as to screw the screw into a material to be fastened, e.g., wood (not shown), for example. The above describes a state when the hammer 40 performs normal striking on the anvil 60. In this embodiment, however, the hammer 40 is formed with three striking claws and the anvil 60 is formed with three blade parts respectively for performing characteristic striking. The striking is to adopt one of the following to control the striking of the hammer 40 on the anvil 60: performing one-skip striking by setting the rotation speed of the motor 4 to a high-speed region of a predetermined revolution speed T₁ or more; or performing continuous striking by setting the rotation speed to a low-speed region of a predetermined revolution speed T₂ or less (T₁>T₂). Moreover, in a region where the revolution speed of the motor 4 is more than T₂ but less than T₁, one-skip striking is not possible and continuous striking may result in over shoot. Therefore, it is preferable not to use the rotation region of T₂-T₁ for the striking operation.

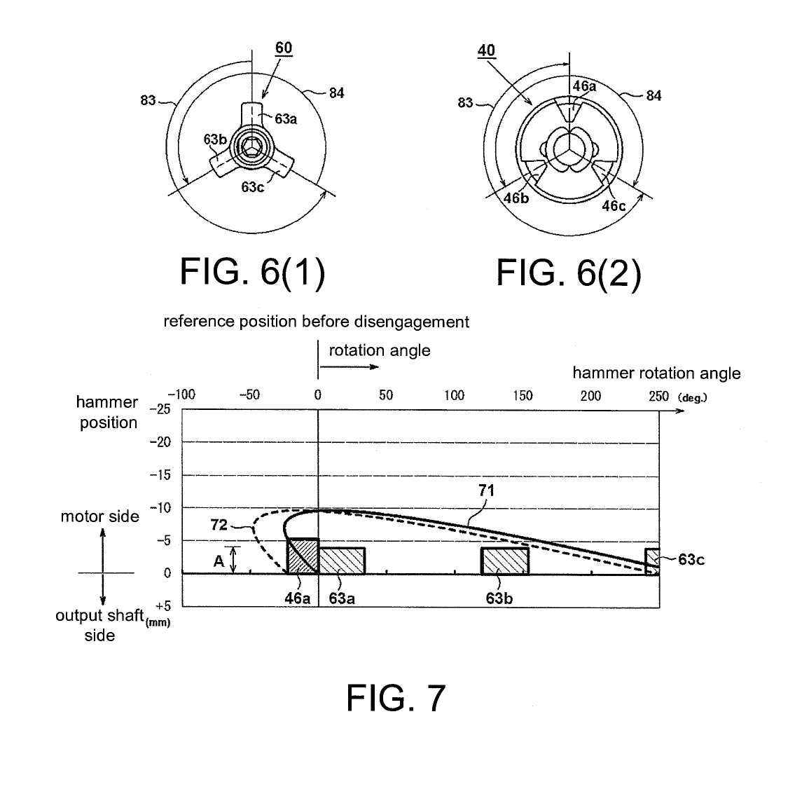

FIG. 6(1) and FIG. 6(2) are views for illustrating a striking angle during one-skip striking of the hammer 40 and the anvil 60. The impact tool 1 of this embodiment is configured to perform the so-called “one-skip striking” when a high torque is required. The configuration is that the anvil 60 has the blade parts 63a-63c as three struck claws and the hammer 40 has the striking claws 46a-46c as three striking claws. Rotation angles 83 and 84 indicated by the arrows indicate the relative rotation angles of the hammer 40 with respect to the anvil 60. The striking claw 46a of the hammer 40 on a rotation side rotates by the rotation angle 83 to strike the blade part 63c after passing the rear side of the blade part 63a of the anvil 60. After being disengaged from the striking claw 46a of the hammer 40, the blade part 63a does not contact the next striking claw 46b and is engaged with the striking claw 46c following the next striking claw 46b. At the moment, the rotation angle is about 240 degrees. After the relative rotation of the rotation angle 83 of the hammer 40 is performed, the relative rotation of the rotation angle 84 is performed. The striking claw 46a of the hammer 40 rotates by the rotation angle 84 to strike the blade part 63b after passing the rear side of the blade part 63c. It is preferable that the rotation portion including the rotation angle 83 of the hammer 40 and the rotation portion including the rotation angle 84 of the hammer 40 (the rotation angle 83 or 84+the rotation angle of the anvil 60) are the same angles. However, since the hammer 40 and the spindle 30 are slightly relatively rotatable in the rotational direction, the hammer 40 and the anvil 60 may be different in a rotation range of 220-260 degrees.

FIG. 7 is a diagram showing a condition of the hammer 40 and the anvil 60 when the striking is performed based on the striking angle of FIG. 6(1) and FIG. 6(2). The vertical axis indicates the position of the hammer 40 in the front-rear direction relative to the anvil 60, wherein “+” indicates the hammer 40 is on the front side of the anvil 60 while “−” indicates the hammer 40 is on the rear side of the anvil 60, and the value indicates the distance (mm). 0 indicates a front-side position of the striking claw 46a of the hammer 40 during rotation in a stationary or low-load state, and at the moment, a front-side position of the blade part 63a is 0 as well. The horizontal axis indicates the relative rotation angle of the hammer 40 with respect to the anvil 60, wherein one round is 360 degrees. Here, the blade parts 63a-63c are respectively arranged at an interval of 120 degrees. When the trigger 6a is pulled to the full and the spindle 30 rotates at a high speed, a predetermined counter force is applied to the striking claw 46a of the hammer 40 and when the counter force exceeds the disengaging torque, the hammer 40 retreats. When the retreat amount of the hammer 40 becomes larger than the maximum engagement amount A with the blade part 63a, the striking claw 46a and the blade part 63a are released from the engagement state and the striking claw 46a rotates and slips through the rear side of the blade part 63a and passes the rear side of the next blade part 63b to strike the following blade part 63c (the blade part that comes after the next blade part with respect to the blade part 63a). In the diagram, a solid line 71 indicates a locus of movement of a corner part of the striking claw 46a on the axial direction front side and the rotational direction front side while a dotted line 72 indicates a locus of movement of a corner part of the striking claw 46a on the axial direction front side and the rotational direction rear side. Thus, in order that the striking claw 46a skips the next blade part 63b to strike the blade part 63c following the next blade part 63b when the striking is performed, the spindle 30 is rotated at a sufficiently high speed such that the hammer 40 that has compressed the spring 54 and moved to the rear side passes the blade part 63b before returning to the axial direction front side. Although FIG. 7 only illustrates the striking claw 46a, the striking claws 46b and 46c also perform the one-skip striking in the same manner. Therefore, despite that the impact tool 1 of the invention has a longer striking interval than the conventional impact tool that has two striking claws and two blade parts, the impact tool 1 is able to achieve a high striking torque. Moreover, for carrying out this striking method, the spring force of the spring 54 may be set substantially equal to the current products. Therefore, increase of the disengaging torque resulting from enhancement of the spring 54 can be suppressed and the impact tool creates a favorable feeling in transition from continuous rotation to the striking state and is easy to use. The spring constant of the spring 54 is preferably set to 40 kgf/cm or less, for example.

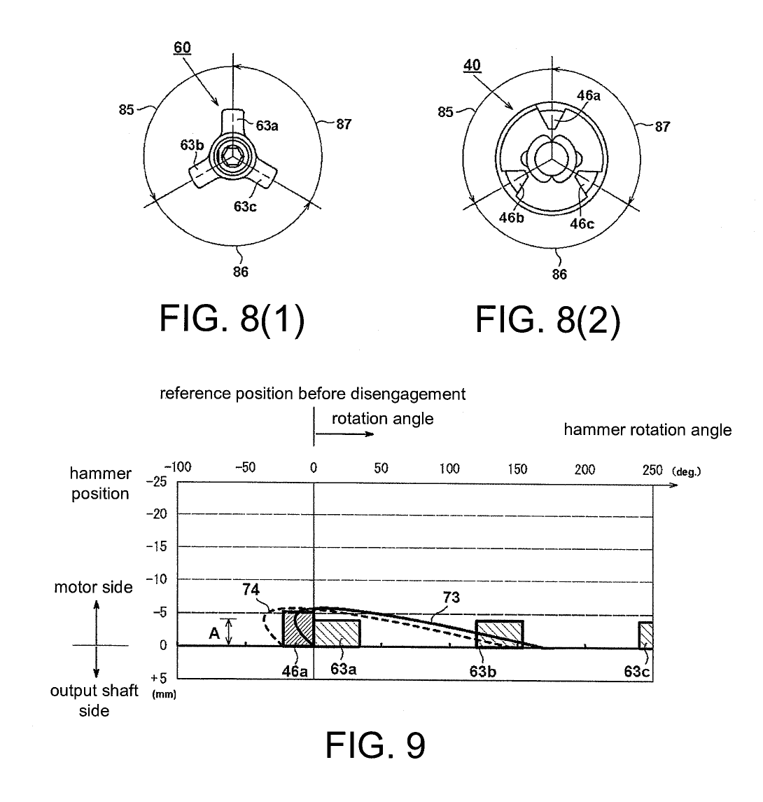

FIG. 8(1) and FIG. 8(2) are views for illustrating the striking angle during continuous striking of the hammer 40 and the anvil 60. Rotation angles 85-87 indicated by the arrows indicate the relative rotation angles of the hammer 40 with respect to the anvil 60. The impact tool 1 of this embodiment is configured to perform the so-called “continuous striking” when a high torque is not required, e.g., when a pulling amount of the trigger 6a is small or when a set revolution speed of the motor 4 is low. The striking claw 46a of the hammer 40 on the rotation side rotates by the rotation angle 85 to strike the blade part 63b after passing the rear side of the blade part 63a of the anvil 60. Then, the striking claw 46a rotates by the rotation angle 86 to strike the blade part 63c after passing the rear side of the blade part 63b. Further, the striking claw 46a rotates by the rotation angle 87 to strike the blade part 63a after passing the rear side of the blade part 63c. In addition, after being disengaged from the striking claw 46a, the blade part 63a is engaged with the next striking claw 46c of the hammer that has rotated by the rotation angle 85. At the moment, the rotation angle of the hammer 40 with respect to the anvil 60 is approximately 120 degrees. After the striking of the rotation angle 85 is performed, the striking of the rotation angle 86 is performed and then the striking of the rotation angle 87 is performed, and in the same manner, the striking of the striking claw of the hammer on the next struck claw is performed. Here, the rotation angle 85, the rotation angle 86, and the rotation angle 87 are preferably the same. However, it should be noted that, because the rotation angles may be set to be different from one another in the rotation range of 100-160 degrees (for example, the rotation angle 85 may be 110 degrees, the rotation angle 86 may be 130 degrees, and the rotation angle 87 may be 120 degrees), the aforementioned “approximately 120 degrees” refers to an angle in a predetermined range.

FIG. 9 is a diagram showing a condition of the hammer 40 and the anvil 60 when the striking is performed based on the striking angle of FIG. 8(1) and FIG. 8(2). The vertical axis and the horizontal axis have the same relationship as FIG. 7. During rotation of the spindle 30 in the low-speed mode, a predetermined counter force is applied to the striking claw 46a of the hammer 40 and when the predetermined counter force exceeds the disengaging torque, the hammer 40 retreats, and when the retreat amount of the hammer 40 becomes larger than the maximum engagement amount A with the blade part 63a, the striking claw 46a and the blade part 63a are released from the engagement condition and the striking claw 46a rotates and slips through the rear side of the blade part 63a and is engaged with the next blade part 63b. In the diagram, a solid line 73 indicates a locus of movement of the corner part of the striking claw 46a on the axial direction front side and the rotational direction front side while a dotted line 74 indicates a locus of movement of the corner part of the striking claw 46a on the axial direction front side and the rotational direction rear side. Thus, in order that the striking claw 46a is properly engaged with the next blade part 63b when the striking is performed, the spindle 30 needs to be rotated at a lower speed than the rotation condition of FIG. 7, so as to bring the next blade part 63b as the hammer 40 that has compressed the spring 54 and moved to the rear side returns to the axial direction front side. Therefore, when performing the continuous striking, the control circuit performs rotation control on the motor 4 so as to rotate the spindle 30 at a low rotation speed for properly carrying out the continuous striking. Although FIG. 9 only illustrates the striking claw 46a, the striking claws 46b and 46c also perform the continuous striking in the same manner. Since the striking interval at the moment is shorter than the striking interval of the conventional impact tool that has two striking claws and two blade parts, the striking torque decreases correspondingly. Thus, in the case of fastening a drywall screw or the like into soft wood, the striking can be reliably carried out by the striking mode, and therefore the impact tool is easy to use.

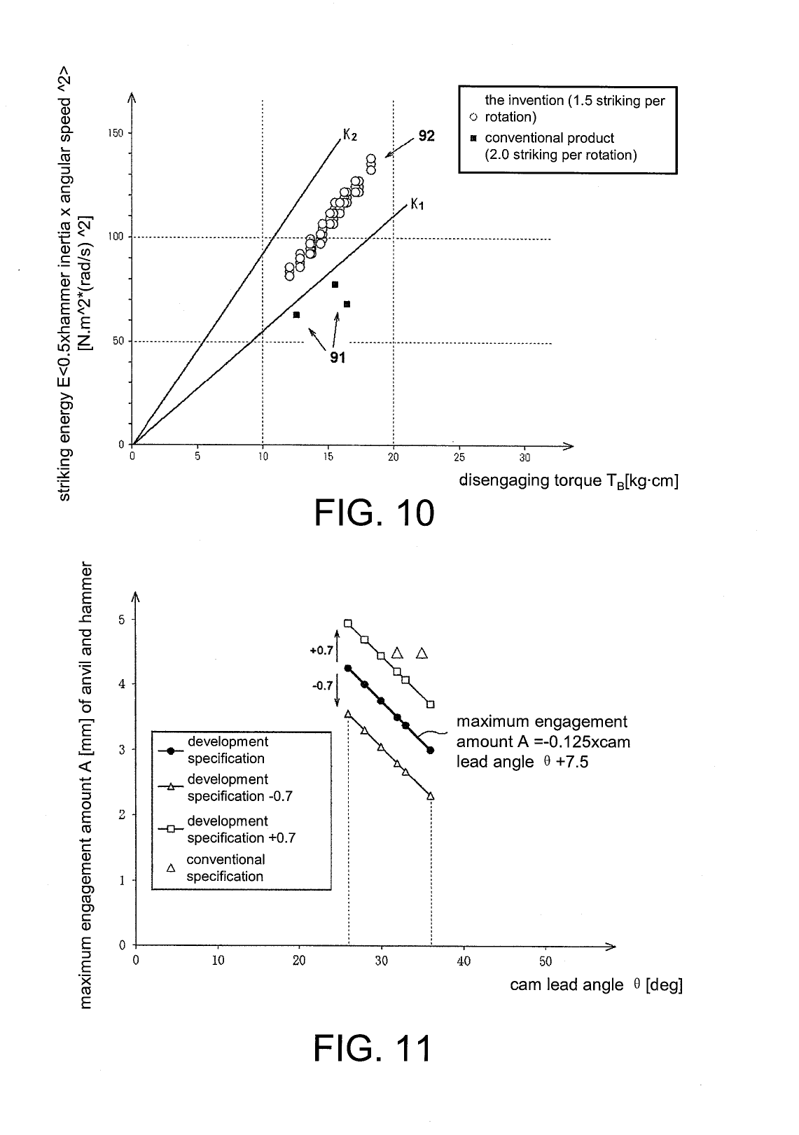

FIG. 10 is a diagram showing a relationship between striking energy and the disengaging torque of the impact tool 1 of this embodiment. The striking energy E is the energy that the hammer 40 has right before the hammer 40 strikes the anvil 60. Here, it is calculated based on the conditions that the operation amount (pulling amount) of the trigger 6a is at the maximum, the material to be fastened is lauan material (wood), and the repulsion rate is 0.31. The disengaging torque T_{B} [kg·cm] and the striking energy E [N·m²×(rad/s)²] shown here are values obtained by the following equation 1 and equation 2.

Disengaging torque T_{B} [kg·cm]=spring constant [kg/cm]×(spring pressing height) [cm]×tan(cam lead angle [deg]×cam contact radius [cm]) Equation 1:

However, the spring pressing height [cm] is a value obtained by subtracting the spring height [cm] at the time of disengagement from the free length [cm] of the spring (1.1 cm in this embodiment).
The cam lead angle θ [deg] is θ_{H} [deg] and θ_{S} [deg].
The cam contact radius [cm] is a distance from the central axis of the spindle 30 to the center point of the R shape of the cam (the arc notch of the cam) formed in the spindle (0.7 cm in this embodiment). The disengaging torque T_{B} shown here indicates a disengaging torque in the stationary state and may be easily obtained based on the respective dimensions of the aforementioned parts.

Striking energy E [N·m²×(rad/s)²]=0.5×hammer inertia [N·m²]×(speed right before hammer striking [rad/s])² Equation 2:

However, the speed right before hammer striking [rad/s]=spindle angular speed [rad/s]+(spindle angular speed [rad/s]×a coefficient considering the repulsion rate)

Spindle angular speed [rad/s]=2×π×spindle revolution speed [rps]

The coefficient considering the repulsion rate is 1.9 in this embodiment.
Furthermore, the spindle revolution speed shown here indicates the spindle revolution speed during the screw fastening operation. If the practical revolution speed of the rotor 4a during the screw fastening operation is to be verified, it may be easily obtained based on the reduction ratio of the planetary gears. In addition, the coefficient considering the repulsion rate varies according to the hardness of the wood. FIG. 10 as described below shows the striking energy E based on the aforementioned values.

The plot points shown in FIG. 10 are obtained by respectively plotting the striking specifications of the invention and the conventional technology. FIG. 10 shows the striking energy E and the disengaging torque T_{B} in the case where the rotation angle till engagement of the striking claw 46a of the hammer with the next blade part 63b of the anvil after disengagement of the striking claw 46a from the blade part 63a is set to 120 degrees, and the range of a coefficient K are represented as an upper limit coefficient K₂ and a lower limit coefficient K₁. A plot group 91 indicates the relationship between the striking energy E and the disengaging torque T_{B} of the current product available in the market. According to the conventional technology, in order to further enhance the striking energy E, the spring pressure of the spring 54 needs to be increased and consequently the disengaging torque T_{B} increases as well. The reason is that, as shown in equation 2, when the rotation speed of the spindle 30, which is the most influential factor, is raised to enhance the striking energy, the spring constant needs to be increased considering the purpose of achieving proper striking timing within the rotation angle of 180 degrees. Nevertheless, if the spring pressure of the spring 54 increases, the disengaging torque T_{B} in the lower region of the solid line K₁ increases and exceeds the practical upper limit, i.e., T_{B}=20 kg·cm, which will impair the practicality.

In contrast thereto, in the case when the rotation angle of the impact tool is such that the rotation angle till engagement with the next blade part 63b after disengagement from the blade part 63a of the anvil is 220-260 degrees, the relationship between a coefficient K_{P} and the striking energy E and the disengaging torque T_{B} of the impact tool is set as E=K_{P}×T_{B}[K₁<K_{P}], as indicated by a plot group 92, the striking energy E can be improved significantly while the disengaging torque is maintained at 12-18 kg·cm, and thus it is possible to obtain high striking energy E in the upper region with respect to the region of the solid line K₁. The reason is that, by setting the rotation angle as large as 220-260 degrees, the spindle revolution speed can be increased with an equal or less disengaging torque.

Thus, the striking mechanism having three striking claws and three struck claws is used in this embodiment to perform striking in the region where the relationship between the striking energy E and the disengaging torque T_{B} satisfies E>5.3×T_{B}. Meanwhile, setting an appropriate disengaging torque T_{B} is also important. For instance, if the disengaging torque T_{B} is overly small, there is a risk that the striking operation may be performed even in the fastening operation or drilling operation that requires no striking. On the other hand, if the disengaging torque T_{B} is overly large, the counter force from the impact tool 1 may hinder the fastening operation that the operator performs with one hand. According to the results verified by the inventors, one-handed operation is almost impossible in the case of 25 kg·cm or more. Moreover, because practically the upper limit of the disengaging torque T_{B} is about 20 kg·cm, the disengaging torque TB is set to about 10-20 kg·cm or more preferably about 12-18 kg·cm.

Furthermore, the control may be switched to perform the so-called continuous striking, in which the rotation angle till engagement with the second blade part 63b after disengagement from the first blade part 63a of the anvil 60 is 100-160 degrees. The relationship with respect to the striking energy E in this case is not shown in FIG. 10. However, the striking energy E substantially equal to or less than the plot group 91 can be obtained and therefore it is suitable for fastening particularly short screws into wood.

FIG. 11 is a diagram showing a relationship between the maximum engagement amount A [mm] and the cam lead angle θ [deg] of the impact tool 1 according to this embodiment of the invention. According to the inventors' experiment, the impact tool that has a high disengaging torque T_{B} and creates a favorable striking feeling is realized by the striking specification that uses the maximum engagement amount A of the anvil and the hammer calculated based on Equation 3: A [mm]=−0.125×θ [deg]+7.5, with respect to the cam lead angle θ (=θ_{H}=θ_{S}). Further, at the moment, by significantly increasing the spindle revolution speed to perform one-skip striking, the striking energy E is enhanced significantly as compared with the conventional technology. In addition, if the spindle revolution speed is significantly reduced during transition to the striking operation to perform continuous striking, the feeling from continuous striking to the start of the striking is improved. Besides, in equation 3, the range of the maximum engagement amount A may be adjusted in a range of ±0.7. The range of the cam lead angle θ (=θ_{H}=θ_{S}) at the moment is preferably about 26-36 degrees.

### Embodiment 2

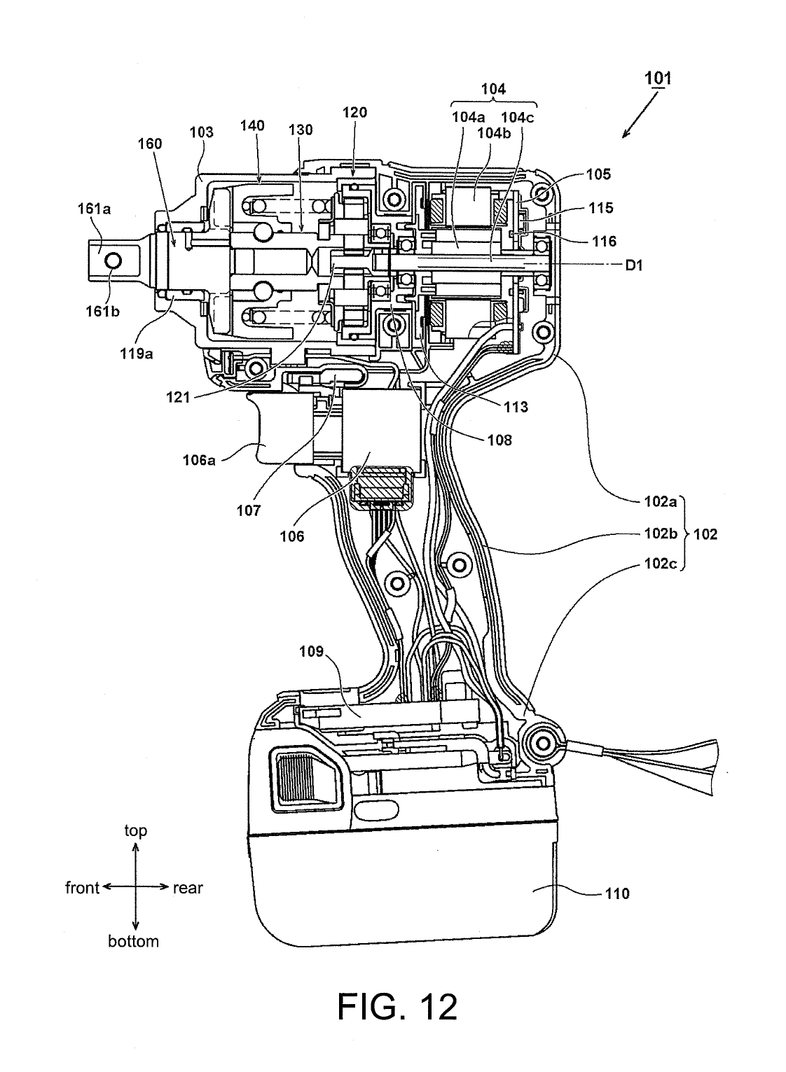

Next, the second embodiment of the invention is described with reference to FIG. 12 to FIG. 22. The hammer 40 described in the first embodiment includes three striking claws. However, the method of carrying out the “one-skip striking” as described in the first embodiment is also applicable to the structure of the conventional impact tool, in which the anvil has two blade parts and the hammer has two striking claws, and the striking claws and the blade parts are respectively at positions separated by an angle of 180 degrees. FIG. 12 is a longitudinal cross-sectional view showing the internal structure of an impact tool 101 according to the second embodiment of the invention. The impact tool 101 has the same basic structure as the impact tool 1 of FIG. 1, except that the number of the claws of the hammer and the number of the blade parts of the anvil are both two.

The impact tool 101 uses a battery 110 as a power source and a brushless type motor 104 as a driving source to drive a rotational striking mechanism. The motor 104 is a brushless DC motor that includes a rotor 104a and a stator core 104b. On the rear of the stator core 104b, a plurality of switching elements 115 and an inverter circuit board 105 that carries a plurality of rotational position detecting elements 116 at predetermined intervals are disposed. A cooling fan 113 is disposed to a rotation shaft 104c on the front side of the motor 104. The output of the motor 104 is transmitted to a spindle 130 via a speed reduction mechanism and the power is transmitted to a hammer 140 and an anvil 160 rotated by the spindle 130. The foregoing rotational striking mechanism is housed inside a metallic hammer case 103 and the internal space thereof is applied with a sufficient amount of grease. The anvil 160 is pivotally supported by a metal 119a to be rotatable. An attachment part 161a that has a quadrangular cross-sectional shape perpendicular to an axial direction D1 is formed on an end of the anvil 160. A hole 161b is formed on a side surface of the attachment part 161a. A tip tool such as hexagonal socket (not shown) is mounted on the attachment part 161a and then fixed by inserting a pin (not shown) into the hole 161b, so as to perform various operations such as bolt fastening.

A trigger switch 106 including a trigger 106a and a forward-reverse switching lever 107 are disposed in the upper portion of a handle part 102b that extends downward from a body part 102a of a body housing 102. An enlarged diameter part 102c is formed in the lower end portion of the handle part 102b. In the enlarged diameter part 102c, a control circuit board 109 is housed for control of rotation of the motor 104. The control circuit board is disposed to be substantially horizontal and a microcomputer (not shown) is mounted there.

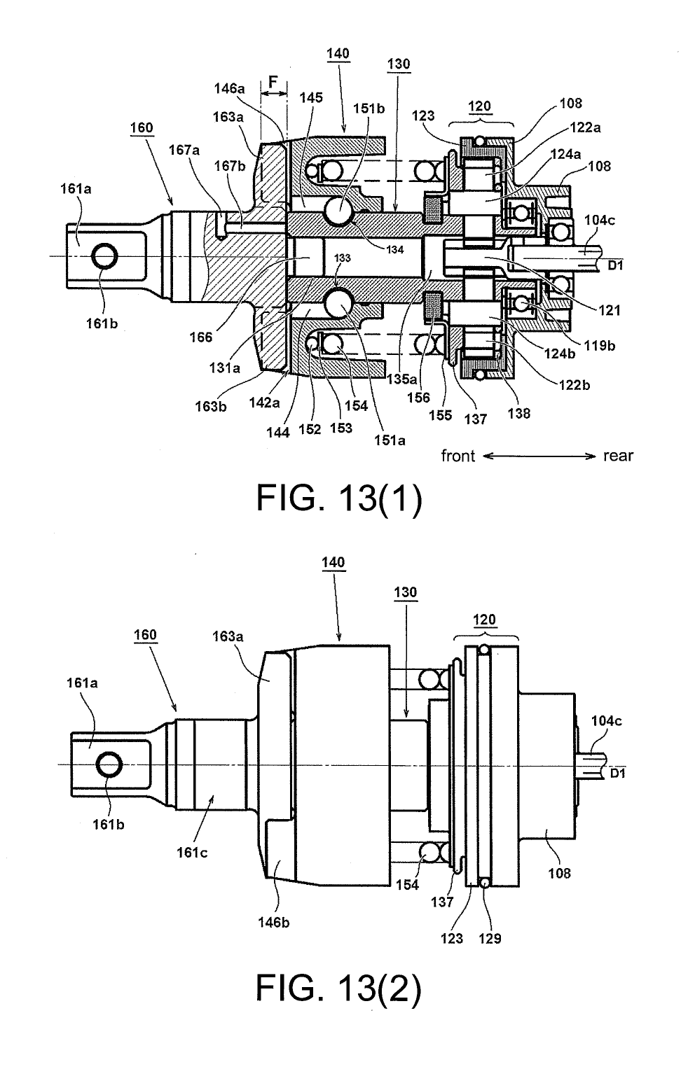

FIG. 13(1) and FIG. 13(2) are partially enlarged views of the power transmission mechanism part from the rotation shaft 104c of the motor 104 to the attachment part 161a of FIG. 12. FIG. 13(1) is a cross-sectional view and FIG. 13(2) is a side view. Because the spindle of the conventional impact tool has a small diameter, the cam lead angle θ needs to be increased to gain the hammer back amount. On the other hand, in order to perform the one-skip striking like the invention, the rotation angle of the two-claw tool should be larger than that of the three-claw tool (the rotation angle of the hammer becomes 360 degrees) and therefore requires an increased hammer back amount. To increase the cam lead angle, however, the axial direction dimension of the spindle needs to be increased. When the front-rear direction dimension of the tool increases or only the lead angle is increased, the disengaging torque increases as well, which impairs the usability. On the other hand, it is also considered to weaken the spring that urges the hammer for the hammer to rotate one round, but by doing so the striking force drops. Therefore, in the second embodiment, the spindle diameter is made larger than the conventional diameter, that is, a large-diameter spindle is used, so as to gain the hammer back amount without increasing the lead angle.

The rotational driving force of the motor 104 is transmitted from the rotation shaft 104c to the side of the rotational striking mechanism via a speed reduction mechanism 120 that uses planetary gears. The speed reduction mechanism 120 transmits the output of the motor 104 to the spindle 130. Here, the speed reduction mechanism that uses planetary gears is adopted. The speed reduction mechanism 120 includes a sun gear 121 fixed to an end of the rotation shaft 104c of the motor 104, a ring gear 123 disposed to surround the sun gear 121 at a distance on the outer peripheral side, and a plurality of planetary gears 122a and 122b (here, the number is two) disposed between and engaged with the sun gear 121 and the ring gear 123. The two planetary gears 122a and 122b revolve around the sun gear 121 while rotating around shafts 124a and 124b respectively. The ring gear 123 is fixed to the side of the body housing 102 and does not rotate. The shafts 124a and 124b are fixed to planetary carrier parts (attachment parts 137 and 138) that are formed on the rear end portion of the spindle 130. The revolution motion of the planetary gears 122a and 122b is converted into the rotational motion of the planetary carrier parts to rotate the spindle 130.

Spindle cam grooves 133 and 134 are formed on the outer peripheral side of the cylindrical spindle 130, and the planetary carrier parts of the speed reduction mechanism 120 are connected to the rear side. These are manufactured integrally from a piece of metal. An internal space of the spindle 130 on the side of the motor 104 is a cylindrical hole 135a that serves as a housing space of the sun gear 121 and a shaft part 166 of the anvil 160 is housed in a fitting hole 131a on the front side on the side of the anvil 160.

The hammer 140 is mounted from the front side (left side of the figure) of the spindle 130 and is disposed such that the outer peripheral surface of the shaft part of the spindle 130 and a portion of the inner peripheral surface of the hammer 140 on the rear side are in contact with each other. The spindle cam grooves 133 and 134 are recessed portions respectively having a substantially V shape in the side view. Hammer cam grooves 144 and 145 are formed on the inner peripheral surface of the hammer 140 opposite to the spindle cam grooves 133 and 134. Metallic cam balls 151a and 151b are disposed in a space formed by the spindle cam grooves 133 and 134 and the hammer cam grooves 144 and 145. The cam mechanism allows the hammer 140 to rotate substantially in linkage with the spindle 130. The cam balls 151a and 151b move in the space, by which the relative positions of the hammer 140 and the spindle 130 in the rotational direction are slightly changeable, and a large rearward movement in the axial direction is possible. The hammer 140 is constantly urged toward the front side by a spring 154 disposed on the rear side.

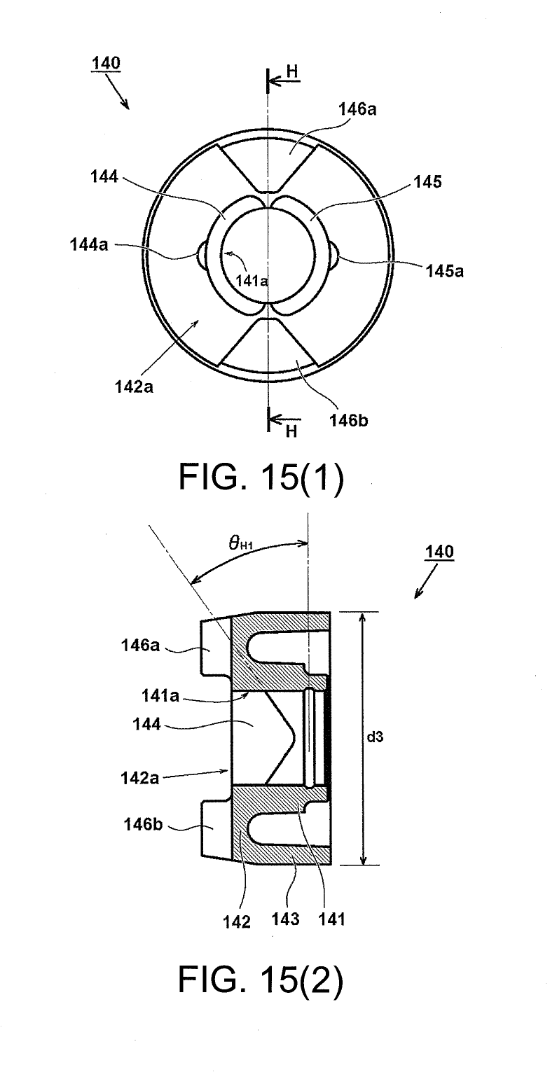

When the spindle 130 is stationary, a front surface 142a of the hammer 140 and a rear end surface of a claw part of the anvil 160 are at positions spaced by a slight gap in the axial direction. Meanwhile, the blade part 163a of the anvil 160 and the striking claw 146a of the hammer 140 are in a positional relationship that they overlap each other when viewed in the direction of the axis D1, and a length of the engagement in the axial direction is an engagement amount F. Here, the engagement amount F is an axial length of a contact area of the striking claws 146a and 146b of the hammer 140 (refer to FIG. 15(1) and FIG. 15(2)) and the blade parts 163a and 163b of the anvil 160 when viewed in the direction of the axis D1, and as shown in FIG. 13(1) and FIG. 13(2), the engagement amount F has a maximum value when they are stationary or at the initial positions before striking. The engagement amount F changes according to the rearward movement of the hammer 140.

The spring 154 is a compression spring. On the front side of the spring 154, a plurality of steel balls 152 are disposed in a state of being pressed by a washer 153, and the rear side of the spring 154 is held on the attachment part 137 of the spindle 130 by a washer 155 having an inner peripheral side that extends in the axial direction to form a cylindrical shape and an outer peripheral side that is annular. A damper 156 composed of a cylindrical elastic body is disposed between the cylindrical portion of the washer 155 and the spindle 130. A rotation body of the anvil 160, the hammer 140, and the spindle 130 as shown in FIG. 13(1) is pivotally supported in the hammer case 103 by a metal 119a (refer to FIG. 12) on the cylindrical surface 161c on the front side and is pivotally supported on a bearing holder 108 (refer to FIG. 13(1) and FIG. 13(2)) by a bearing 119b on the outer peripheral surface of the rear side end. An annular gap portion that is continuous in the circumferential direction is formed on an outer peripheral side joint of the ring gear 123 and the bearing holder 108, and an O ring 129 is interposed there. The space in the hammer case 103 (refer to FIG. 12) on the front side with respect to the O ring 129 is applied with a sufficient amount of grease or the like.

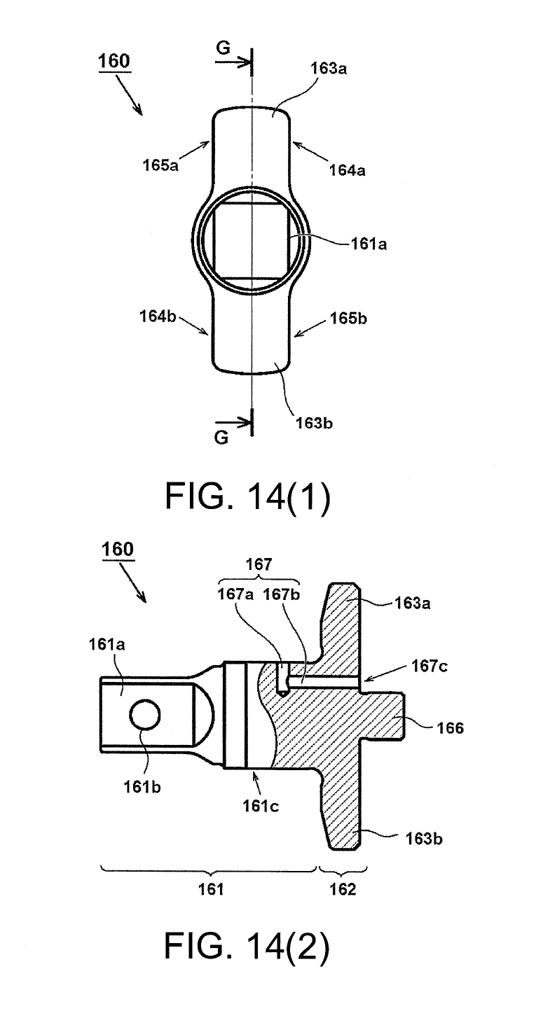

FIG. 14(1) is a front view of the anvil 160 and FIG. 14(2) is a cross-sectional view along the section G-G of FIG. 14(1). In the first embodiment described above, the number of the claws of the hammer 40 and the number of the blade parts of the anvil 60 are both three so as to realize two operation modes, i.e., performing one-skip striking by setting the rotation speed of the motor 4 to the high-speed region of the predetermined revolution speed or more, and performing continuous striking by setting the rotation speed to the low-speed region of the predetermined revolution speed or less. In the second embodiment, however, the one-skip striking and continuous striking are realized by the impact tool that the number of the claws of the hammer 140 and the number of the blade parts of the anvil 160 are both two. If the revolution speed of the spindle 130 is in the predetermined speed region or less, continuous striking is performed in the same manner as the conventional impact tool. However, by skipping the predetermined speed region (intermediate speed region) and rotating the motor 4 in the even faster high-speed region, the fastening operation of “one-skip striking” is also possible.

The anvil 160 is manufactured integrally from a piece of metal, wherein a struck part 162 with the blade parts 163a and 163b is formed at the rear of a cylindrical output shaft part 161, as shown in FIG. 14(2). The outer peripheral surface 161c substantially near the center when viewed in the axial direction is formed into a columnar shape. An oil supply hole 167 including an axial direction groove 167b and a radial direction groove 167a is formed on the anvil 160 for supplying grease to the metal 119a from the side of an opening 167c. The oil supply hole 167 may be formed by drilling in the radial direction and the axial direction with use of a drill. The two blade parts 163a and 163b of the struck part 162 are struck claws that are separated by an angle of 180 degrees when viewed in the rotational direction and extend outward in the radial direction. On side surfaces of the blade parts 163a and 163b in the rotational direction, struck surfaces 164a and 164b and struck surfaces 165a and 165b are formed, wherein the struck surfaces 164a and 164b are to be struck by the striking claws of the hammer 140 during rotation in the fastening direction, and the struck surfaces 165a and 165b are formed on the opposite sides to be struck during rotation in the loosening direction. A columnar shaft part 166 is formed on the axial direction rear side of the struck part 162, and the outer peripheral surface of the shaft part 166 is pivotally supported by the fitting hole 131a of the spindle 130 in a slidable manner (refer to FIG. 13(1) and FIG. 13(2)).

Next, a shape of the hammer 140 is described with reference to FIG. 15(1) and FIG. 15(2). FIG. 15(1) is a front view of the hammer 140 and FIG. 15(2) is a cross-sectional view along the section H-H of FIG. 15(1). As shown in FIG. 15(2), the hammer 140 has a shape that front sides of two cylindrical portions 141 and 143 that have different inner diameters are connected by a connection part 142 in the radial direction. Here, the hammer 140 is made of a metal, which is basically a specification for better performance. It is preferable to make the hammer size as large as possible if the hammer can be housed in the hammer case 103, and a diameter (outer diameter) d3 thereof is preferably 44 mm or more. Moreover, the outer diameter of the hammer 140 is preferably less than four times the shaft diameter of the spindle 130. The two striking claws 146a and 146b that protrude toward the front side (the side of the anvil 160) in the axial direction are formed at two opposite positions on the outer peripheral side of the front surface 142a which is formed by the connection part 142. The striking claws 146a and 146b are equally arranged in a way that the central positions of the striking claws 146a and 146b are respectively separated by a rotation angle of 180 degrees when viewed in the rotational direction. Two side surfaces of each of the striking claws 146a and 146b in the rotational direction are arranged at predetermined angles in the rotational direction to achieve proper surface contact when colliding with the two blade parts 163a and 163b of the anvil 160. The hammer cam grooves 144 and 145 are formed on the inner peripheral side of the cylindrical portion 141 of the hammer 140 and on an inner wall portion of a through hole 141a which faces the outer surface (cylindrical surface) of the spindle 130. Here, it can be understood that the through hole 141a is formed with a larger diameter than the through hole 41a of the hammer 40 as shown in FIG. 4(1) and FIG. 4(2). Therefore, sufficient lengths of the hammer cam grooves 144 and 145 in which the cam balls 151a and 151b move are ensured. The hammer cam grooves 144 and 145 are recesses, which respectively have a substantially trapezoidal contour if the inner peripheral surface of the hammer 140 is unfolded into a plane, and form a space that restricts movement of the cam balls 151a and 151b with the spindle cam grooves 133 and 134. In addition, grooves 144a and 145a for inserting the cam balls 151a and 151b during assembly are formed on a portion of the hammer cam grooves 144 and 145. Because the rotation angle of the hammer is set to two angles, 180 degrees and 360 degrees, in this embodiment, a cam lead angle θ_{M} of the hammer 140 is set within a range of θ_{H1}=16-36 degrees such that the cam lead angle θ_{M} is a predetermined value. This value is sufficiently low as compared with the conventional impact tool and forms a structure for laying down the cam lead angle. Additionally, the maximum revolution speed of the motor is preferably set to about 18,000-27,000 rpm. In this case, the revolution speed of the spindle 130 is 2,100-3,150 rpm.

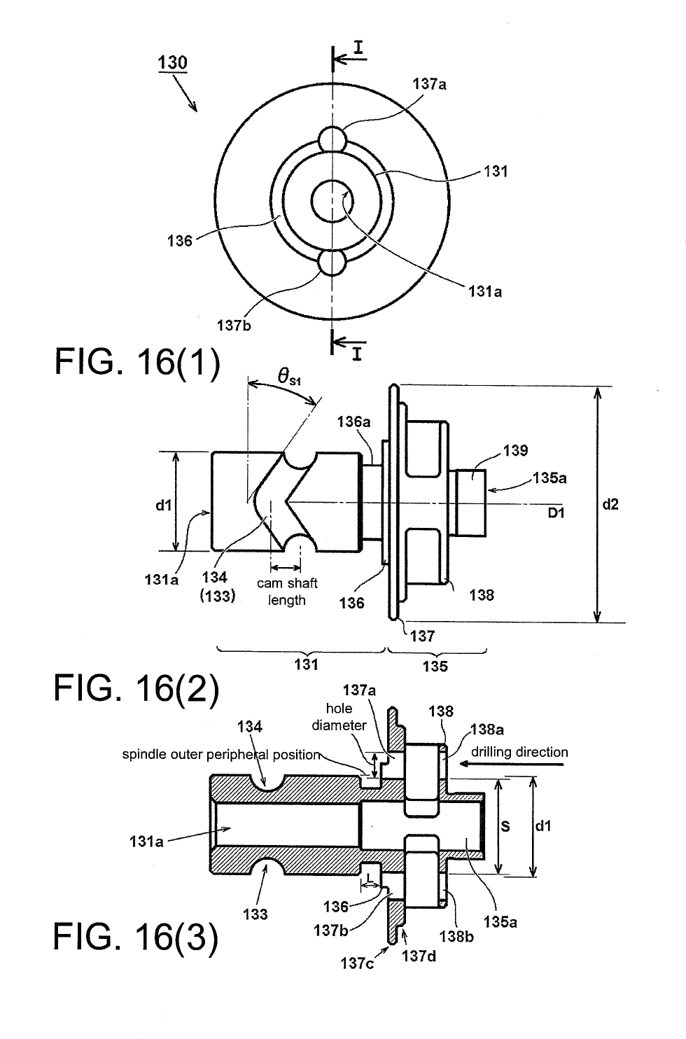

Next, a shape of the spindle 130 is described with reference to FIG. 16(1), FIG. 16(2), and FIG. 16(3). FIG. 16(1) is a front view of the spindle 130, FIG. 16(2) is a side view, and FIG. 16(3) is a cross-sectional view along the section I-I of FIG. 16(1). The spindle 130 is made of a metal and has a substantially cylindrical shape and is disposed between the anvil 160 and the speed reduction mechanism 120. A rear end part 139 of the spindle 130 in the longitudinal direction is pivotally supported by the bearing 119b (refer to FIG. 13(1) and FIG. 13(2)). A diameter d1 of the shaft part 131 of the spindle 130 is preferably 16 mm or more. Here, the diameter d1 is set to 18 mm to be sufficiently larger than the diameter of the spindle 30 shown in FIG. 5(1) and FIG. 5(2). Since the spindle 130 is thick, even though the cylindrical internal space is formed hollow to communicate the fitting hole 131a on the front end side and the cylindrical hole 135a on the rear end side, sufficient strength is ensured. The hollow structure allows the internal space to be filled with grease and facilitates supplying the grease to the anvil side, and therefore is advantageous in terms of lubricity. Two sets of spindle cam grooves 133 and 134 are formed on the outer peripheral surface of the spindle 130. Here, the spindle cam grooves 133 and 134 respectively have a substantially V shape in the side view (when viewed in a direction orthogonal to the axis D1), and a cam lead angle ν_{S1} of each of the spindle cam grooves 133 and 134 is set to a predetermined angle. In the second embodiment, the cam lead angle θ_{H1} of the hammer 140 and the cam lead angle ν_{S1} of the spindle are set to be the same in the range of 16-30 degrees, for example, to relatively reduce the cam lead angle θ_{M}. Even though the cam lead angle θ_{H1} is reduced, the diameter d1 of the spindle 130 is large and the circumferential length is long. Accordingly, the distance for movement of the cam balls 151a and 151b is increased to ensure a sufficient retreat amount of the hammer 140 (hammer back amount).

On the rear side of the shaft part 131 of the spindle 130, a planetary carrier part 135 of the speed reduction mechanism 120 is formed. Disk-shaped attachment parts 137 and 138 are formed on the planetary carrier part 135. The attachment part 137 has a shape formed by connecting a large-diameter part 137c on the front side and a small-diameter part 137d on the rear side. The attachment part 137 extends in a direction orthogonal to the axis D1 and is formed with two fitting holes 137a and 137b that are arranged at equal intervals in the rotational direction. The attachment part 138 is disposed in parallel to the attachment part 137 on the rear side of the attachment part 137 at a predetermined distance from the attachment part 137. The attachment part 138 is also formed with two fitting holes 138a and 138b that are arranged at equal intervals in the rotational direction and, together with the fitting holes 137a and 137b, fix the shafts 124a and 124b (both refer to FIG. 13(1) and FIG. 13(2)) for pivotally supporting the planetary gears 122a and 122b. The shafts 124a and 124b may have substantially the same hole diameter (diameter) as the first embodiment. However, in the case of the second embodiment, the positions for forming the fitting holes 137a, 137b, 138a, and 138b cause problems. Generally, a drill that moves in parallel to the axial direction from the rear side is used to form the fitting holes 137a, 137b, 138a, and 138b. At the moment, in order that the tip of the drill that protrudes toward the front side of the attachment part 137 does not process the spindle shaft part 131, a diameter S of a circle contacting the innermost peripheral points of the fitting holes 137a and 137b needs to be larger than the diameter d1 of the spindle shaft part 131. The structure shown in FIG. 5(1) also follows such a positional relationship (refer to FIG. 2). In contrast thereto, in this embodiment, the inner diameter of the diameter S of the circle contacting the innermost peripheral points of the fitting holes 137a and 137b is configured to be smaller than the diameter d1 of the spindle shaft part 131. In other words, the diameter d1 of the spindle 130 (the shaft part 131) is made larger than the diameter S of the innermost peripheral circle of the fitting holes 137a and 137b. That is, the spindle 130 and the fitting holes 137a and 137b overlap in the radial direction. In order to realize this positional relationship, a groove part 136a is formed on the front side of the attachment part 137 by cutting to reduce the outer diameter. During the drilling process performed by using the drill, the tip of the drill does not contact the outer peripheral surface on the side of the spindle shaft part 131. The result is that the diameter S of the circle contacting the innermost peripheral points of the fitting holes 137a and 137b may be equal to the conventional diameter and does not increase excessively. Thus, even if the spindle shaft part 131 has a large diameter, increase of a diameter d2 of the planetary carrier part 135 is prevented. In addition, the groove part 136a is convenient for the groove part 136a may also be used as a space for disposing the damper 156 such as annular rubber. A stepped part 136 having an increased thickness in the axial direction is formed on the front side of the attachment part 137, and the rear side surface of the damper 156 is held by the stepped part 136.

The spindle 130 and the hammer 140 are connected by the cam mechanism, and when the spindle 130 is driven to rotate, the rotation is transmitted to the hammer 140 via the cam mechanism. When the rotation begins and before the hammer 140 reaches ½ of the rotation, the striking claws 146a and 146b of the hammer 140 abut the blade parts 163a and 163b of the anvil 160 and cause the anvil 160 to rotate. At the moment, when the engagement counter force from the anvil 160 causes relative rotation between the spindle 130 and the hammer 140, the hammer 140 starts to retreat toward the side of the motor 104 while compressing the spring 154 along the spindle cam grooves 133 and 134 of the cam mechanism. Then, when the retreat of the hammer 140 causes the striking claws 146a and 146b of the hammer 140 to move over the blade parts 163a and 163b of the anvil 160 to release the hammer 140 and the anvil 160 from the engagement state, the hammer 140 is rapidly accelerated forward and rotated in the rotational direction by the elastic energy accumulated in the spring 154 and the function of the cam mechanism in addition to the rotational force of the spindle 130.

When the hammer 140 is moved forward by the urging force of the spring 154, the striking claws 146a and 146b of the hammer 140 are engaged with the next blade parts 163b and 163a of the anvil 160 again after the rotation, so as to perform strong striking and the hammer 140 and the anvil 160 start to rotate integrally. The striking applies a strong rotational force to the anvil 160. Thus, a rotational striking force is transmitted to a fastener member, such as a bolt, through the socket (not shown) which is mounted on the attachment part 161a of the anvil 160. Thereafter, the same operation is repeated to intermittently and repeatedly transmit the rotational striking force from the socket to the fastener member. The above describes a state when the hammer 140 performs normal striking on the anvil 160. Like the first embodiment, the impact tool 101 of the second embodiment is also configured to perform one-skip striking by setting the rotation speed of the motor 104 to a high-speed region of a first revolution speed T₃ or more. Moreover, by driving the motor 104 in a low-speed region of a second revolution speed T₄ or less, the impact tool 101 is able to perform continuous striking Here, the relationship between the revolution speed T₄ and the revolution speed T₃ is T₄<T₃, and in either the high-speed region or the low-speed region, the revolution speed of the spindle 130 may be set to an appropriate value to prevent pre hit or over shoot.

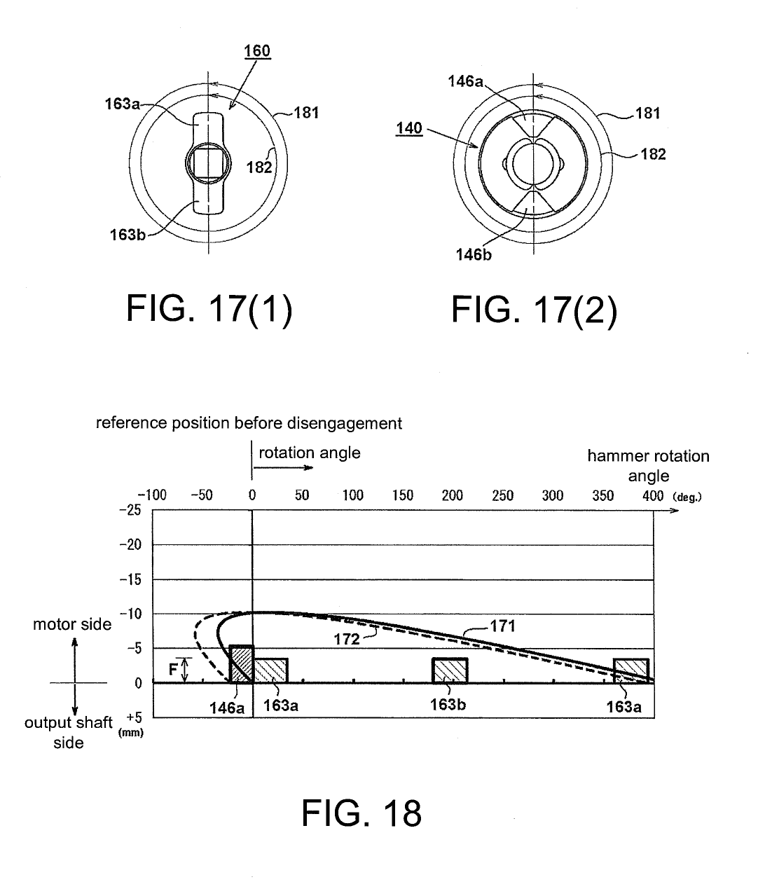

FIG. 17(1) and FIG. 17(2) are views for illustrating a striking angle during one-skip striking of the hammer 140 and the anvil 160. The striking claw 146a of the hammer 140 rotates by a rotation angle 181 to strike the blade part 163a of the anvil 160 after passing the rear side of the blade part 163a of the anvil 160. Then, the striking claw 146a rotates by a rotation angle 182 to strike the blade part 163a of the anvil 160 in the same manner after passing the rear side of the blade part 163a. After the striking claw 146b of the hammer 140 is disengaged from the blade part 163b of the anvil 160, the striking claw 146b is engaged with the blade part 163b again without contacting the blade part 163a. At the moment, the rotation angle is about 360 degrees. After the relative rotation of the rotation angle 181 of the hammer 140 is performed, the relative rotation of the rotation angle 182 is performed. The rotation angle 181 and the rotation angle 182 are preferably the same.

FIG. 18 is a diagram showing a condition of the hammer 140 and the anvil 160 when the striking is performed based on the striking angle of FIG. 17(1) and FIG. 17(2). The vertical axis indicates the position of the hammer 140 in the front-rear direction, wherein “+” indicates the hammer 140 is on the front side while “−” indicates the hammer 140 is on the rear side, and the value indicates the distance (mm) 0 indicates a front-side position of the striking claw 146a of the hammer 140 during rotation in a stationary or low-load state, and at the moment, a front-side position of the blade part 163a is 0 as well. The horizontal axis indicates the relative rotation angle of the hammer 140 with respect to the anvil 160, wherein one round is 360 degrees. When the trigger 106a is pulled to the full and the spindle 130 rotates at a high speed, a predetermined counter force is applied to the striking claw 146a of the hammer 140 and when the counter force exceeds the disengaging torque, the hammer 140 moves rearward in the axial direction. The retreat amount of the hammer 140 with respect to the spindle 130 (hammer back amount) is determined by the cam shaft length×2. When the retreat amount of the hammer 140 becomes larger than the maximum engagement amount F with the blade part 163a (refer to FIG. 13(1) and FIG. 13(2)), the striking claw 146a and the blade part 163a are released from the engagement state and the striking claw 146a rotates and slips through the rear side of the blade part 163a and passes the rear side of the next blade part 163b to strike the following blade part, i.e., the original blade part 163a. In the diagram, a solid line 171 indicates a locus of movement of a corner part of the striking claw 146a on the axial direction front side and the rotational direction front side while a dotted line 172 indicates a locus of movement of a corner part of the striking claw 146a on the axial direction front side and the rotational direction rear side. Thus, in order that the striking claw 146a skips the next blade part 163b to strike the blade part 163a following the next blade part 163b when the striking is performed, the spindle 130 is rotated at a sufficiently high speed such that the striking claw 146a passes the rear side of the blade part 163b without contacting the blade part 163b before the hammer 140 that has compressed the spring 154 and moved to the rear side returns to the axial direction front side. At the point of the rotation angle of 200 degrees, the axial direction front position of the striking claw 146a passes a portion that is separated from the blade part 163a of the anvil 160 by 3 mm or more. In addition, although FIG. 18 only illustrates the striking claw 146a, the striking claw 146b also performs one-skip striking in the same manner. Therefore, a high striking torque is achieved.

According to the second embodiment, the back amount of the hammer 140 can be increased without increasing the dimensions of the spindle 130 in the axial direction and thus, by properly setting the revolution speed of the motor 104, one-skip striking can be performed. Furthermore, the outer diameter of the hammer 140 is maintained equivalent to the conventional dimension while the inner diameter (the diameter of the spindle 130) is increased. Thereby, the inertia of the hammer 140 decreases and the hammer is easy to rotate during one-skip striking. Moreover, through control to perform one-skip striking, the maximum revolution speed of the motor is significantly improved in comparison with the conventional speed. The striking force at the moment is (hammer inertia)×(spindle angular speed)̂2 as shown by equation 2 of the first embodiment. Therefore, even though the inertia of the hammer 140 is reduced by 10%, for example, when the rotation speed is raised by 30%, the striking force is maintained equivalent to the conventional striking force or higher. Here, it is assumed that the striking energy E of the current product is E=1/2×1.0×1.0̂2=0.50 in (equation 1), when the hammer inertia is set smaller than the current product and the spindle angular speed is set higher than the current product for comparison, the relationship between the angular speed up and the striking energy E is as follows.

E=1/2×0.9×1.3̂2=0.76 [improved by 1.52 times] Example 1:

E=1/2×0.8×1.3̂2=0.68 [improved by 1.36 times] Example 2:

E=1/2×0.8×1.5̂2=0.90 [improved by 1.8 times] Example 3:

Thus, in the case of performing one-skip striking, an advantage is that even though the hammer inertia is reduced, since the revolution speed is significantly increased, the striking force is greatly enhanced. Moreover, for a specification with a high revolution speed and large hammer inertia, there is a problem that the hammer back amount also increases significantly. Further, when the spring constant of the hammer spring is raised to cope with the aforementioned problem, the disengaging torque increases and impairs the usability. Therefore, in this embodiment, the optimal hammer inertia and motor rotation speed are adopted to achieve a striking force equivalent to or higher than the conventional force without increasing the tool size. In addition, because the disengaging torque at the moment can be reduced as well, the two-claw specification is able to carry out one-skip striking and the impact electric tool achieves both high performance and usability.

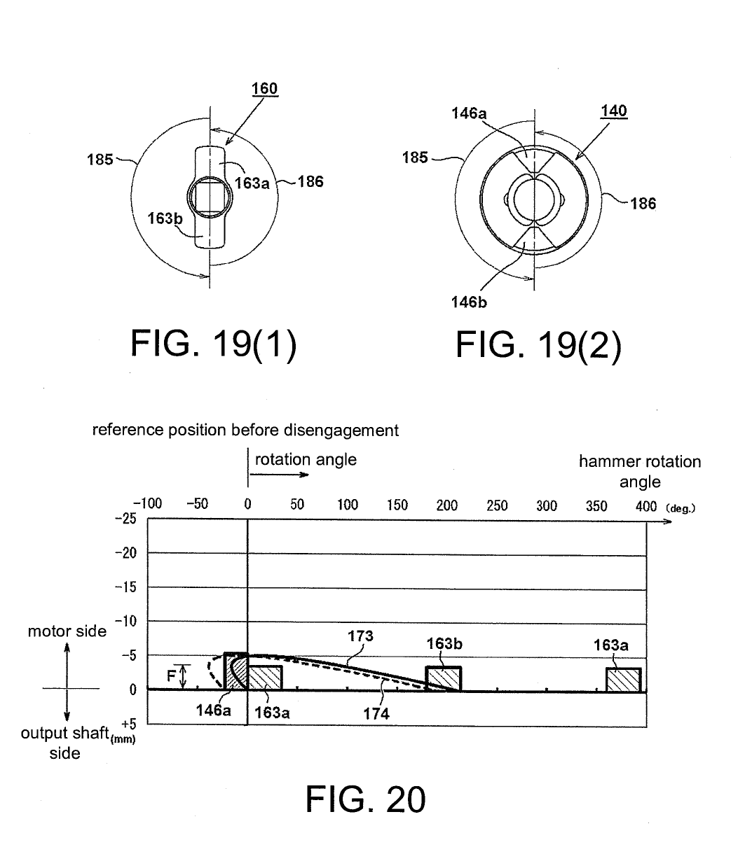

FIG. 19(1) and FIG. 19(2) are views for illustrating the striking angle during continuous striking of the hammer 140 and the anvil 160. The striking claw 146a of the hammer 140 on the rotation side rotates by a rotation angle 185 to strike the blade part 163b of the anvil 160 after passing the rear side of the blade part 163a of the anvil 160. Then, the striking claw 146a of the hammer 140 rotates by a rotation angle 186 to strike the blade part 163a of the anvil 160 after passing the rear side of the blade part 163b of the anvil 160. At the moment, the rotation angle is approximately 180 degrees. Thereafter, the striking of the striking claw of the hammer on the next struck claw is performed in the same manner. Here, the rotation angle 185 and the rotation angle 186 are preferably the same. However, the aforementioned “approximately 180 degrees” refers to an angle in a predetermined range.

FIG. 20 is a diagram showing a condition of the hammer 140 and the anvil 160 when the striking is performed based on the striking angle of FIG. 19(1) and FIG. 19(2). The vertical axis and the horizontal axis have the same relationship as FIG. 18. During rotation of the spindle 130 in the low-speed mode, a predetermined counter force is applied to the striking claw 146a of the hammer 140 and when the counter force exceeds the disengaging torque, the hammer 140 retreats. When the retreat amount of the hammer 140 becomes larger than the maximum engagement amount F with the blade part 163a, the striking claw 146a and the blade part 163a are released from the engagement state and the striking claw 146a rotates and slips through the rear side of the blade part 163a to be engaged with the next blade part 163b. In the diagram, a solid line 173 indicates a locus of movement of the corner part of the striking claw 146a on the axial direction front side and the rotational direction front side while a dotted line 174 indicates a locus of movement of the corner part of the striking claw 146a on the axial direction front side and the rotational direction rear side. Thus, in order that the striking claw 146a is properly engaged with the next blade part 163b when the striking is performed, rotation of the motor 104 is controlled to rotate the spindle 130 at a low speed, so as to bring the next blade part 163b as the hammer 140 that has compressed the spring 154 and moved to the rear side returns to the axial direction front side. Although FIG. 20 only illustrates the striking claw 146a, the striking claw 146b also performs the continuous striking in the same manner.

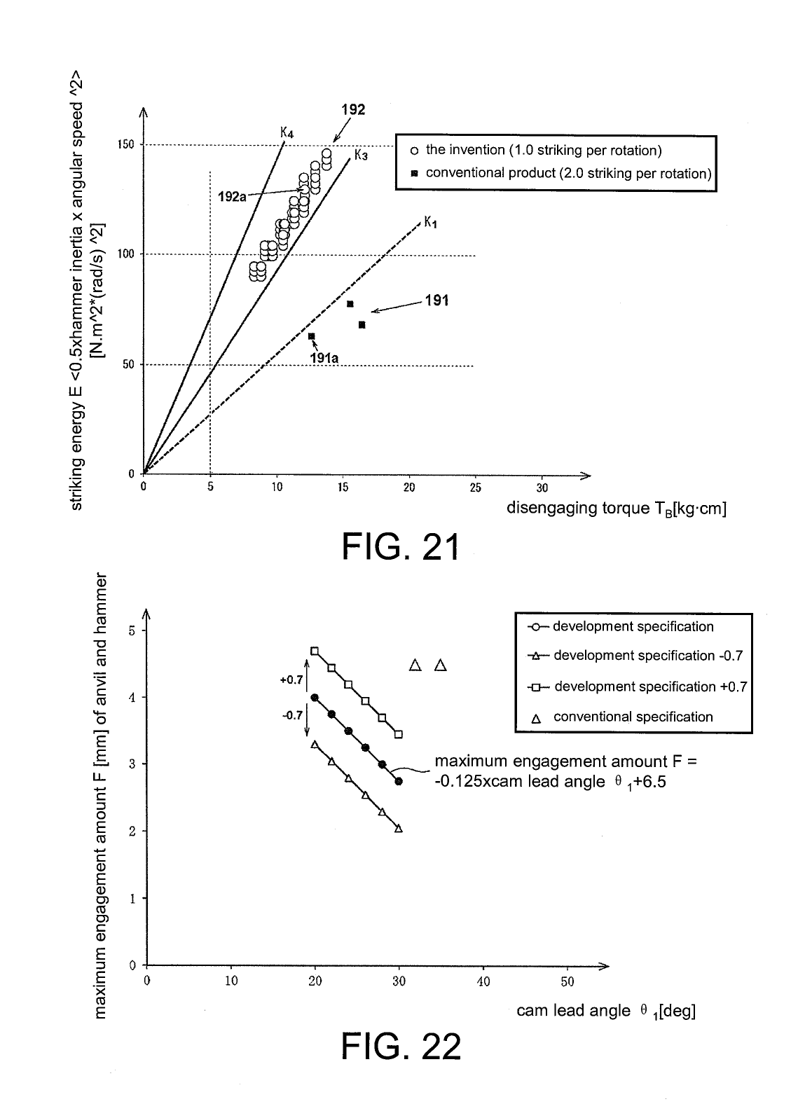

FIG. 21 is a diagram showing a relationship between the striking energy E and the disengaging torque T_{B} of the impact tool 101 of this embodiment. The striking energy E is the energy that the hammer 140 has right before the hammer 140 strikes the anvil 160. Here, it is calculated based on the conditions that the operation amount (pulling amount) of the trigger 106a is at the maximum, the material to be fastened is lauan material (wood), and the repulsion rate is 0.31. The disengaging torque T_{B} [kg·cm] and the striking energy E [N·m²×(rad/s)²] shown here are the same as the values obtained by the equation 1 and equation 2 of the first embodiment. The plot points shown in FIG. 21 are obtained by respectively plotting the striking specifications of the invention and the conventional technology. FIG. 21 shows the striking energy E and the disengaging torque T_{B} in the case where the rotation angle till engagement of the striking claw 146a of the hammer with the next blade part 163b of the anvil after disengagement of the striking claw 146a from the blade part 163a is set to 180 degrees, and the range of a coefficient K are represented as an upper limit coefficient K₃ and a lower limit coefficient K₄. A plot group 191 indicates the relationship between the striking energy E and the disengaging torque T_{B} of the current product available in the market. As described above, according to the conventional technology, in order to further enhance the striking energy E, the spring pressure of the spring 154 needs to be increased and consequently the disengaging torque T_{B} also increases and impairs the practicality.

In contrast thereto, in the case when the rotation angle of the impact tool is such that the rotation angle till engagement with the next blade part 163b after disengagement from the blade part 163a of the anvil is 360 degrees, the relationship between a coefficient K_{P} and the striking energy E and the disengaging torque T_{B} of the impact tool is set as E=K_{P}×T_{B}[K₁<K_{P}], as indicated by a plot group 192, the striking energy E can be improved significantly while the disengaging torque is maintained at 7-15 kg·cm, and thus it is possible to obtain high striking energy E in the upper region with respect to the region of the solid line K₃.

Thus, in this embodiment, the striking mechanism having two striking claws and two struck claws, same as the conventional technology, is used to perform striking in the region where the relationship between the striking energy E and the disengaging torque T_{B} satisfies 15.0×T_{B}>E>9.3×T_{B}. Meanwhile, the impact tool is able to perform not only one-skip striking but also continuous striking. The striking energy E in the case of continuous striking is in the relationship as indicated by the arrow 192a during one-skip striking and in the relationship as indicated by the arrow 191a (or thereunder) during continuous striking. Therefore, in a case where a low striking torque is sufficient, e.g. fastening particularly short screws into wood, continuous striking is performed so as to carry out the fastening process with an appropriate striking torque.

FIG. 22 is a diagram showing a relationship between the maximum engagement amount F [mm] and the cam lead angle θ₁ [deg] of the impact tool 101 according to this embodiment of the invention. According to the inventors' experiment, the impact tool that has a high disengaging torque T_{B} and creates a favorable striking feeling is realized by the striking specification that uses the maximum engagement amount F of the anvil and the hammer calculated based on Equation 4: F [mm]=−0.125×θ₁ [deg]+6.5, with respect to the cam lead angle θ₁ (=θ_{H1}=θ_{S1}). Further, at the moment, by significantly increasing the spindle revolution speed to perform one-skip striking, the striking energy E is enhanced significantly as compared with the conventional technology. In addition, if the spindle revolution speed is significantly reduced during transition to the striking operation to perform continuous striking, the feeling from continuous rotating to the start of the striking is improved. Besides, in equation 4, the range of the maximum engagement amount F may be adjusted in a range of ±0.7. The range of the cam lead angle θ₁ (=θ_{H1}=θ_{S1}) at the moment is preferably about 16-36 degrees.

Although the invention has been described based on the two embodiments above, the invention should not be construed as limited to the aforementioned embodiments, and various modifications may be made without departing from the spirit of the invention. For instance, the hammer and anvil described above are respectively provided with the same number (two or three) of striking claws and struck claws, but the number of the striking claws of the hammer and the number of the struck claws of the anvil may be changed to other numbers, and the invention is also applicable to an impact tool that the number of the striking claws differs from the number of the struck claws.

What is claimed is:

1. An electric tool, comprising:
a motor;
a spindle driven in a rotational direction by the motor;
a hammer relatively movable in an axial direction and the rotational direction in a predetermined range with respect to the spindle and urged forward by a cam mechanism and a spring; and
an anvil disposed rotatably in front of the hammer to be struck by the hammer when the hammer rotates while moving forward,
wherein a relationship between a striking energy E, which the hammer has right before the hammer strikes the anvil, and a disengaging torque T_{B}, which is applied between the hammer and the anvil right before the hammer is disengaged from the anvil, is set as E>5.3×T_{B}.

2. The electric tool according to claim 1, wherein the hammer comprises three striking claws that are arranged equally in the rotational direction while the anvil comprises three struck claws that are arranged equally in the rotational direction, and
a range of a relative rotation angle of the hammer with respect to the anvil from when the hammer strikes the anvil till the hammer strikes the anvil again after the hammer stroke the anvil and moved rearward is set to substantially 240 degrees.

3. The electric tool according to claim 2, wherein the relationship between the striking energy E, which the hammer has right before the hammer strikes the anvil, and the disengaging torque T_{B}, which is applied between the hammer and the anvil right before the hammer is disengaged from the anvil, is set as 5.3×T_{B}<E<9.3×T_{B}.

4. The electric tool according to claim 3, wherein when a maximum engagement amount, which is an engagement length of the anvil and the hammer in the axial direction when the anvil is at a foremost position, is set to A [mm] and a cam lead angle, which is a lead angle between cams disposed on the hammer and the spindle such that the hammer retreats when the hammer rotates relatively with respect to the spindle, is set to θ [deg], a relationship between A and θ is set as (−0.125×θ+7.5)−0.7<A<(−0.125×θ+7.5)+0.7.

5. The electric tool according to claim 4, wherein an overlapping length of the striking claws and the struck claws in the axial direction when a counter torque received from a tip tool mounted on the anvil is small is 2.3 mm-5.0 mm, and lead angles θ of a cam groove of the hammer and a cam groove of the spindle are made equal and set as θ=26-36 degrees.

6. The electric tool according to claim 5, wherein a diameter of the hammer is 35 mm-44 mm and an inertia of the hammer is 0.39 kg·cm²[0.00038 N·m²] or less.

7. The electric tool according to claim 6, wherein a diameter of the spindle is 10 mm-15 mm and a spring constant of the spring is 40 kgf/cm or less.

8. The electric tool according to claim 3, comprising a trigger switch adjusting a rotation speed of the motor,
wherein when the trigger switch is pulled to a maximum or to an extent close to the maximum, the rotation speed of the spindle is adjusted such that the striking claw moves over the next struck claw to strike the struck claw following the next struck claw, and
when the trigger switch is pulled slightly, the rotation speed of the spindle is adjusted such that the striking claw strikes the next struck claw when the hammer retreats to disengage the striking claw from the struck claw and rotates.

9. The electric tool according to claim 1, wherein the hammer comprises two striking claws that extend in opposite directions while the anvil comprises two struck claws at opposite positions, and
a range of the relative rotation angle of the hammer with respect to the anvil from when the hammer strikes the anvil till the hammer strikes the anvil again after the hammer stroke the anvil and moved rearward is set to substantially 360 degrees.

10. The electric tool according to claim 9, wherein the relationship between the striking energy E, which the hammer has right before the hammer strikes the anvil, and the disengaging torque T_{B}, which is applied between the hammer and the anvil right before the hammer is disengaged from the anvil, is set as 9.3×T_{B}<E<15.0×T_{B}.

11. The electric tool according to claim 10, wherein when a maximum engagement amount, which is an engagement length of the anvil and the hammer in the axial direction when the anvil is at a foremost position, is set to F [mm] and a cam lead angle, which is a lead angle between the cams disposed on the hammer and the spindle such that the hammer retreats when the hammer rotates relatively with respect to the spindle, is set to θ₁ [deg], a relationship between F and θ₁ is set as (−0.125×θ₁+6.5)−0.7<F<(−0.125×θ₁+6.5)+0.7.

12. The electric tool according to claim 11, wherein an overlapping length of the striking claws and the struck claws in the axial direction when a counter torque received from a tip tool mounted on the anvil is small is 2.3 mm-5.0 mm, and lead angles θ₁ of a cam groove of the hammer and a cam groove of the spindle are made equal and set as θ₁=16-30 degrees.

13. An electric tool, comprising:
a motor;
a spindle driven in a rotational direction by the motor;
a hammer relatively movable in an axial direction and the rotational direction in a predetermined range with respect to the spindle and urged forward by a cam mechanism and a spring;
an anvil disposed rotatably in front of the hammer to be struck by the hammer when the hammer rotates while moving forward; and
a trigger switch adjusting a rotation speed of the motor,
wherein when the trigger switch is pulled to a predetermined extent or more, the electric tool performs one-skip striking that a striking claw of the hammer moves over a next struck claw of the anvil to strike a struck claw following the next struck claw, and
when the trigger switch is pulled less than the predetermined extent, the electric tool performs continuous striking that the striking claw strikes the next struck claw.

14. An electric tool, comprising:
a motor;
a spindle driven in a rotational direction by the motor;
a hammer comprising two striking claws, wherein the hammer is relatively movable in an axial direction and the rotational direction in a predetermined range with respect to the spindle and urged forward by a cam mechanism and a spring;
an anvil comprising two struck claws and disposed rotatably in front of the hammer to be struck by the hammer when the hammer rotates while moving forward; and
a trigger switch adjusting a rotation speed of the motor,
wherein an outer diameter d1 of a shaft of the spindle is 16 mm or more and an outer diameter d3 of the hammer is less than four times the outer diameter d1, and
a lead angle between cams disposed on the hammer and the spindle is set to 16-30 degrees.

15. The electric tool according to claim 14, wherein the electric tool performs one-skip striking that the striking claw moves over the next struck claw to strike the struck claw following the next struck claw.

16. The electric tool according to claim 14, wherein the spindle has a cylindrical shape, in which an internal space communicates a front end with a rear end.

17. The electric tool according to claim 14, wherein a plurality of fitting holes are formed on a motor side of a shaft part of the spindle to pivotally support a planetary gear of a planetary gear speed reduction mechanism, and
a diameter S of a circle contacting an innermost peripheral point of the fitting hole is formed smaller than the outer diameter d1 of the shaft of the spindle.
